(19) United States
(12) Patent Application Publication
(10) Pub. No.: US 2019/0023398 A1
(43) Pub. Date: Jan. 24, 2019

(54) Devices and Methods for Pest Control

(71) Applicant: Olfactor Laboratories, Inc., Riverside, CA (US)

(72) Inventors: Rowena Lampa Albanna, Riverside, CA (US); Grey Frandsen, Riverside, CA (US); Belinko K Matsuura, Solana Beach, CA (US); David G Matsuura, Solana Beach, CA (US); Jeffrey J Loos, Solana Beach, CA (US)

(21) Appl. No.: 15/752,251

(22) PCT Filed: Aug. 12, 2016
(86) PCT No.: PCT/US2016/046876

§ 371 Date: Feb. 13, 2018

(51) Int. Cl. B64D 1/12; A01M 99/00; A01M 25/00; A01M 21/04; B64C 39/02

(52) U.S. Cl. CPC B64D 1/12; A01M 99/00; A01M 25/006; A01M 21/043; B64C 39/024; B64D 1/18; B64C 2201/027; B64C 2201/128; B64C 2201/145; B64C 2201/146; B64C 2201/024

(57) ABSTRACT

The present invention provides devices and methods for payload delivery, including payloads for pest control (e.g., biocidal and larvicidal compounds and compositions). Also included are devices and methods for delivering payloads to remote areas by aerial delivery.

### CROSS REFERENCE TO RELATED APPLICATIONS

This application claims priority to U.S. Provisional Patent Application No. 62/204,113 filed Aug. 12, 2015, entitled Devices and Methods for Pest Control, the contents of which are herein incorporated by reference in their entirety.

### FIELD OF THE INVENTION

The present invention relates to the field of pest control as well as methods of delivering compounds and compositions for pest control purposes to bodies of water, including remote bodies of water.

### BACKGROUND OF THE INVENTION

Mosquito-borne illnesses are responsible for the deaths of more than one million people annually. Malaria is one such illness posing a major health problem in tropical and subtropical regions. Another global killer is the Dengue virus, transmitted by Aedes aegypti which infects 100 million people annually primarily in Latin America and Asia. Mosquito-borne illnesses are also on the rise in the United States. Since the first reported human infections in New York State in 1999, the West Nile Virus has steadily moved south and west with detection currently recorded in all of the States of the continental United States. Eastern Equine Encephalitis (EEE) is another arbovirus transmitted by mosquitoes that is also causing illness in individuals in the United States as well as in Central and South America. Serious infections of EEE are characterized by seizures and coma leading to death in about half of these patients. Therefore, there exists a worldwide need for safe, effective and affordable agents to protect humans from mosquitoes and other vector pests.

Many previous methods as well as methods in current practice for controlling mosquito populations rely on chemicals that are harmful to human health as well as to plant and animal species in the environment. One such chemical is N,N-diethyl-meta-toluamide (DEET). DEET was registered as an insect repellent in 1957 after first being used by the military in 1946. There are over 225 DEET containing products registered for use on skin and/or clothing making it the most widely utilized insect repellent in the market. Unfortunately, DEET poses a health hazard in mammals, having been shown to inhibit acetylcholinesterase, an enzyme affecting muscle control. Since the introduction of DEET, very few novel compounds have made it into the market.

One compound that has been introduced since DEET is permethrin. Permethrin is an insecticidal neurotoxin that destabilizes the cell membrane of neurons eventually leading to insect death. Mammalian toxicity for permethrin is low, but it can cause harm when coming in contact with the eyes or lungs. Also, the toxicity of permethrin to aquatic animals and aquatic ecosystems is high.

With increasing awareness of the harmful effects of these chemicals and their control methods, there remains a need in the field to develop methods, compounds and compositions for controlling insect populations and insect behavior while reducing health and environmental effects. Recent advances have shown that pests may be controlled using compounds and compositions that are environmentally safe (REF). Such advances have increased the number of sites where pest control is now possible, including remote sites difficult to reach by land. There remains an unmet need in the field for devices and methods of delivering environmentally friendly and safe compounds and compositions to remote sites in need of pest control.

### SUMMARY OF THE INVENTION

The present invention provides delivery structures for aerial delivery of pest control compounds or compositions to target areas. Such devices may comprise an attachment section for attaching the delivery structure to an aerial delivery vehicle; and one or more delivery units adapted for containing pest control compounds or compositions and adapted for releasing pest control compounds or compositions to target areas. In some cases, the attachment section is adapted to be attached to different aerial delivery vehicles. Some attachment sections comprise one or more spacer elements that connect to a holding rack comprising delivery units. In some cases, holding units comprise 1, 2, 3, 4, 5, 6, 7, 8, 9 or 10 delivery units. Delivery units may be attached to holding racks by one or more releasing units and may be configured for independent actuation to release one or more delivery units to the target area. In some cases, one or more delivery units are attached releasing units by one or more cargo holders and actuation of the releasing units causes one or more cargo holders to be released. Some delivery units may be attached to one releasing unit by two or more cargo holders.

In some embodiments, delivery structures comprise delivery units, which are constructed of environmentally safe and/or biodegradable material. Such delivery units may comprise at least one housing layer configured to break open upon physical contact resulting from delivery. In some cases, these delivery units comprise at least one housing layer that has one or more openings through which pest control compounds or compositions can escape into the target location. Such openings may be sufficiently small to retain pest control compounds or compositions during flight, but sufficiently large to allow entry of water into the housing. In some cases, delivery structures of the invention comprise delivery units with at least one housing layer that is partially or completely constructed of a material that chemically reacts upon exposure to the environment at the target area (e.g., dissolves or degrades) and provides exposure of pest control compounds or compositions to the target area. Such housing layers may dissolve or degrade upon exposure to water.

In some embodiments, delivery structures comprise at least 6 delivery units, wherein the delivery units are released in the order of outermost delivery units to innermost delivery units. In some cases, delivery units comprise at least one buoyancy pocket. Delivery structures may comprise delivery units adapted to contain and release pest control compounds or compositions, wherein pest control compounds or compositions are in the form of a liquid, a slurry, a solid, or a powder. In some cases, delivery units comprised by delivery structures of the invention may comprise an inner housing layer that partially or completely encapsulates pest control compounds or compositions. Such inner housing layers may provide a timed, extended, or controlled release of pest control compounds or compositions to a target area. Inner housing layers may comprise a material which deteriorates or dissolves upon exposure to the environment at the target area. Some inner housing layers deteriorate or dissolve upon exposure to water. In some embodiments, inner housing layers comprise gelatin.

In some embodiments, delivery structures of the invention comprise aerial delivery vehicles that are rotorcrafts. Such rotorcrafts may include multirotorcraft having 4, 6 or 8 rotors.

Delivery structures of the invention may comprise delivery units with pest control compounds or compositions selected from X0001-X0190. These compounds or compositions may include activator, inhibitor, and/or beta activator compounds. In some cases, delivery structures provide for aerial delivery of one or more synergistic combination. Some pest control compounds or compositions associated with delivery structures of the invention comprise one or more biocidal compounds and/or larvicidal compounds. In some cases, pest control compositions associated with delivery structures of the invention comprise a combination selected from Z0152-Z0212. Some such combinations may comprise activator combinations or inhibitor combinations. In some cases, pest control compositions associated with delivery structures of the invention comprise a commercial repellent (e.g., IR3535, lemon eucalyptus, or picardin).

In some embodiments, the present invention provides a system for aerial delivery of a pest control compound or composition to a target area, the system comprising: an unmanned aerial delivery vehicle comprising a wireless network interface and a delivery structure of the invention attached to the aerial delivery vehicle. In some cases, the system further comprises a remote radio controller for piloting the aerial delivery vehicle and/or actuating the delivery structure by a remote operator or remote autonomous system. Systems may also comprise a processor and a memory unit configured to provide autonomous flight control to the aerial delivery vehicle and/or autonomously actuate the delivery structure. Some systems comprise one or more video cameras and/or are able to transmit video images in real time. One or more video cameras may be provided on a pivoted support which provides rotation of the one or more video cameras on one or more axis. In some cases, one or more video cameras may provide first person viewing for pilot viewing and/or drop zone viewing.

In some embodiments, delivery systems of the invention comprise a global positioning system (GPS), with an aerial delivery vehicle configured to transmit the GPS coordinates of the aerial delivery vehicle to a remote operator or remote autonomous system. A remote autonomous system may be programmed to provide automated flight and/or pest control compound or composition delivery instructions to the aerial delivery vehicle based on the GPS coordinates transmitted by the aerial delivery vehicle.

In some embodiments, the present invention provides a system, wherein an aerial delivery vehicle comprises a GPS, a processor and a memory device, the processor providing an autopilot system to the aerial delivery vehicle based on coordinates generated by the GPS system and algorithms stored in the memory unit. Upon receipt of a signal from a remote operator or remote autonomous system, the processor may calculate and effect a flight plan for the aerial delivery vehicle from its current GPS coordinates to the GPS coordinates of a predetermined location. With some systems, if no wireless signals are received from a remote operator or remote autonomous system for a predetermined length of time, the processor initiates an automatic hover mode or effects a flight plan for the aerial delivery vehicle from its current GPS coordinates to the GPS coordinates of a predetermined location.

Also provided herein are kits comprising a delivery structure comprising an attachment section for attaching the delivery structure to an aerial delivery vehicle; and one or more delivery units adapted for containing a pest control compound or composition and adapted for releasing the pest control compound or composition to a target area. Such kits may further comprise a holding rack connected to the attachment section with spacer elements. The holding rack may be articulated to provide different spatial arrangements between the attachment section and the delivery units. Kits may further comprise instructions for (a) assembling the attachment section, one or more delivery units, spacer elements and/or holding rack, (b) attaching the delivery structure to an aerial delivery vehicle, (c) loading a payload within the delivery units, and/or (d) actuating delivery of the delivery units.

In some embodiments, the present invention provides a kit comprising a delivery structure which comprises an attachment section for attaching the delivery structure to an aerial delivery vehicle; and a holding rack with releasing units for attaching delivery units adapted for containing a pest control compound or composition and adapted for releasing the pest control compound or composition to a target area. Delivery units may be adapted for loading of the pest control compound or composition within the delivery unit. In some cases, the pest control compound or composition is within the delivery unit or separate therefrom.

In some embodiments, the present invention provides methods for aerial delivery of pest control compounds or compositions to a target area, comprising delivering the pest control compound or composition to the target area with an aerial delivery vehicle fitted with a delivery structure of the invention. In some cases, the target area is a remote location and/or body of water. According to some methods, pest control compounds or compositions are delivered to two or more target areas without landing the aerial delivery vehicle. Pest control compounds or compositions associated with methods of delivery of the present invention may be selected from any of those presented herein. In some cases, methods of delivery include methods of delivering biocidal compounds to a body of water. Such biocidal compounds may include larvicides.

Delivery units of the invention may comprise at least one housing layer and at least one pest control compound selected from any of those presented herein. Such delivery units may comprise at least one housing layer comprising a capsule. Such capsules may comprise a material that chemically reacts upon exposure to water (e.g., gelatin). Some capsules may comprise a buoyancy pocket.

In some embodiments, delivery structures of the invention are designed for aerial delivery of a payload to a target area. Such devices may comprise an attachment section for attaching the delivery structure to an aerial delivery vehicle and one or more delivery units adapted for containing the payload and adapted for releasing the payload to the target area. Attachment sections of payload delivery structures may be adapted for attachment to different aerial delivery vehicles. Such attachment sections may comprise one or more spacer elements that connect to a holding rack with one or more delivery units. Payload delivery units may be attached to the holding rack by one or more releasing units that may be configured for independent actuation to release one or more delivery units to the target area. Delivery units of payload delivery structures may be attached to releasing units by one or more cargo holders. In some cases, payload delivery units are comprised of biodegradable material or comprise at least one housing layer configured to break open upon physical contact resulting from delivery. One or more delivery units of payload delivery structures may comprise at least one housing layer that dissolves in water or that has one or more openings through which the payload can escape into the target location. Such openings may be sufficiently small to retain the payload during flight, but sufficiently large to allow entry of water into the housing.

Some delivery structures of the invention comprise at least 6 delivery units. Delivery units of such structures may be released in the order of outermost delivery units to innermost delivery units. In some cases, these delivery units comprise at least one buoyancy pocket.

Some delivery structures designed for payload delivery are attached to an aerial delivery vehicle that is a rotorcraft (e.g., a multirotorcraft having 4, 6 or 8 rotors).

In some embodiments, the present invention provides a system for aerial delivery of a payload to a target area, the system comprising: an unmanned aerial delivery vehicle comprising a wireless network interface; and a delivery structure attached to the aerial delivery vehicle. Some systems, further comprise a remote radio controller for piloting the aerial delivery vehicle and/or actuating the delivery structure by a remote operator or remote autonomous system. Some systems comprise a processor and a memory unit configured to provide autonomous flight control to the aerial delivery vehicle and/or autonomously actuate the delivery structure.

Systems for aerial delivery of payloads may comprise one or more video cameras. Such systems may transmit video images in real time. One or more video cameras may be provided on a pivoted support which provides rotation of the one or more video cameras on one or more axis. In some cases, one or more video cameras provide first person viewing for pilot viewing and/or drop zone viewing.

In some embodiments, systems for aerial delivery of payloads may comprise a GPS where the aerial delivery vehicle is configured to transmit the GPS coordinates of the aerial delivery vehicle to a remote operator or remote autonomous system. Such systems may be programmed to provide automated flight and/or payload delivery instructions to the aerial delivery vehicle based on the GPS coordinates transmitted by the aerial delivery vehicle. Further systems may comprise a processor and a memory device, the processor providing an autopilot system to the aerial delivery vehicle based on coordinates generated by the GPS system and algorithms stored in the memory unit. With such systems, upon receipt of a signal from a remote operator or remote autonomous system, the processor may calculate and effect a flight plan for the aerial delivery vehicle from its current GPS coordinates to the GPS coordinates of a predetermined location. With some systems for aerial delivery of payloads, if no wireless signals are received from a remote operator or remote autonomous system for a predetermined length of time, the processor initiates an automatic hover mode or calculates and effects a flight plan for the aerial delivery vehicle from its current GPS coordinates to the GPS coordinates of a predetermined location.

In some embodiments, the present invention provides kits comprising delivery structures which comprise an attachment section for attaching delivery structures to an aerial delivery vehicle; and one or more delivery units adapted for containing a payload and adapted for releasing the payload to a target area. Such kits may further comprise instructions for use, a holding rack, spacer elements, releasing units, delivery units and/or cargo holders. In some kits, the payload is within the delivery unit or separate therefrom.

The present invention also includes methods for aerial delivery of a payload to a target area comprising delivering the payload to the target area with an aerial delivery vehicle fitted with a delivery structure of the invention. In some cases, target areas for payload delivery are remote locations and may be on land or a body of water (e.g., a pond, lake, bog, swamp, estuary, river, stream, brook, marsh, delta, bay, or cove). Some methods comprise delivery of payloads to two or more target areas without landing the aerial delivery vehicle. According to some methods, target areas include harsh environments (e.g., a cave, a rain forest, a building or forest fire, an industrial mining or drilling site, or an area with extreme weather conditions). Delivery units comprising payloads may be dropped individually or simultaneously.

According to some methods of the invention, delivered payloads may be supplies, equipment, sensors, cameras, or unmanned vehicles. In some cases, payloads comprise food, water, medical supplies, and/or rescue supplies or kits.

Some methods of the invention involving aerial delivery of a payload to a target may include the selection of holding racks and or delivery units in the field. In some cases delivery structures are attached to aerial delivery vehicles in the field.

In some embodiments, the present invention provides delivery units comprising at least one housing layer and at least one payload. Housing layers of such delivery units may comprise a capsule. Such capsules may chemically react upon exposure to water (e.g., gelatin capsules). Capsules may further comprise at least one buoyancy pocket. Some payload delivery units may float or sink in water.

In some embodiments, delivery units may comprise at least one cap layer (e.g., an inner cap layer and/or outer cap layer). In some cases, cap layers dissolve and/or give off gas.

In some embodiments, methods of the invention may include a method of reducing the level of vector-borne illness in a subject population including: (a) obtaining a system of the present disclosure, and (b) using the system to deliver at least one pest control compound or composition to a target area, wherein the target area includes, is adjacent to, or is utilized by the subject population. The vector-borne illness may be a mosquito-borne illness. The mosquito-borne illness may be selected from at least one of malaria, Dengue fever, yellow fever, sleeping sickness, West Nile virus infection, Eastern equine encephalitis, river blindness, lymphatic filariasis, leishmaniasis, epidemic polyarthritis, Australian encephalitis, and Zika virus infection. The target area may be a body of water.

According to some embodiments, the present disclosure provides a method of preventing or reducing vector-associated birth defects in a subject population by obtaining a system taught herein and using the system to deliver at least one pest control compound or composition to a target area, wherein the target area includes, is adjacent to, or is utilized by the subject population. The vector-associated birth defects may be caused by a vector-borne illness. The vector-borne illness may include a Zika virus infection. The vector associated birth defects may include microcephaly. The target area may be a body of water. The pest control compound or composition may be a composition having at least one environmentally safe compound. The composition may include lemon grass oil. The composition may include at least one of peppermint oil, thyme oil, wintergreen oil, and vanillin. The composition may be prepared using a repellent concentrate. The repellent concentrate may include peppermint oil, thyme oil, wintergreen oil, vanillin, lemongrass oil, and corn oil. The repellent concentrate may include from about 1 to about 10 weight percent of peppermint oil; from about 20 to about 30 weight percent of thyme oil; from about 10 to about 20 weight percent of wintergreen oil; from about 5 to about 15 weight percent of vanillin; from about 30 to about 40 weight percent of lemon grass oil; and from about 5 to about 15 weight percent of corn oil. The composition may be packed into a delivery unit having at least one housing layer. The housing layer be a capsule. The capsule may include a material that chemically reacts upon exposure to water. The material may be gelatin. The capsule may include at least one buoyancy pocket.

### BRIEF DESCRIPTION OF THE DRAWINGS

The foregoing and other objects, features and advantages will be apparent from the following description of particular embodiments of the invention, as illustrated in the accompanying drawings. The drawings are not necessarily to scale, emphasis instead being placed upon illustrating the principles of various embodiments of the invention.

FIG. 1 is a schematic of one embodiment of a delivery structure 100 comprising an attachment section 101 as indicated by a dotted line outline, spacer elements 102, a holding rack 103, six delivery units 104, releasing units 105, and cargo holders 106.

FIG. 2 is a photograph of delivery system comprising an unmanned rotorcraft with six rotors. The rotorcraft is fitted with a delivery structure shown in FIG. 1.

FIG. 3 is a photograph of an inner housing or “capsule” 301 with buoyancy pocket 302, inner cap layer 303, payload layer 304, and outer cap layer 305.

### DETAILED DESCRIPTION OF THE INVENTION

The present invention provides delivery systems for payload deployment (including payloads comprising pest control compounds or compositions) to target areas. Delivery systems comprise delivery structures attached to delivery vehicles. Delivery structures of the invention comprise an attachment section for attaching the delivery structure to a delivery vehicle (e.g., an aerial delivery vehicle), and one or more delivery units adapted for containing the payload and releasing the payload to the target area.

Delivery structures of the invention provide a means to deliver payloads to any target areas, including those that are remote, those that are harsh environments, or any other areas that are generally difficult to access. Given the tremendous impact vector pests have on the human condition, it is of great interest and imperative that pest control compounds and compositions be able to reach remote areas, including remote bodies of water.

Described herein are devices and methods for controlling pest population levels and/or altering pest behavior in a manner that is beneficial to animals, particularly humans. Many of the compounds and compositions used according to the present invention and taught herein include a number of natural products as well as structurally similar synthetic molecules, potentially making these compounds less harmful to the environment and to human health. Further, many of these compounds and compositions are ideal for mosquito control due to their specificity and low toxicity.

Altered pest behavior may be the result of exposing a pest to compounds or compositions of the present invention in multiple forms. As used herein, the term “exposing” refers to applying a compound or composition to an object, surface, area, or region in such a manner and in sufficient proximity to a pest as to allow the sensing of the compound or composition by the pest. The resulting behavioral alteration may be induced by a compound or composition in the form of an attractant to a site distant from humans or human habitation or it may be induced by a compound or composition in the form of a repellent resulting in the pests being deterred from coming to or toward human beings or their habitats. It may also be induced by compounds and/or compositions in concentrations that saturate pest sensing capabilities with the ultimate outcome being a masking of such sensing. Consequently an activating compound may also become a pest repellent.

Some pests, such as mosquitoes, are able to sense host organisms by detecting molecules that emanate from such hosts. These may include both exhaled molecules (e.g. CO₂) as well as passively emitted molecules that may emanate from one or more regions of host bodies (e.g. skin) (Lu, T. et al., 2007). As used herein, the term “passively emit” refers to odors and/or molecules that emanate from a given source, passively (e.g. in the absence of a propellant force, such as exhalation.) Passively emitted molecules may guide pests to specific feeding locations or surfaces on the host where feeding may be carried out. In some embodiments, the present invention provides compounds and/or compositions that modulate host detection through disruption of pest sensing abilities. Such compounds and/or compositions may modulate either sensing of CO₂, sensing of passively emitted molecules or both.

In some embodiments, pest control compounds and/or compositions may prevent pests from sensing the body or skin of a given host. Such sensing may comprise the detection of odors, gases or other molecules that may emanate from a host.

As used herein, an “attractant” is any compound, composition or combination capable of attracting one or more pests, whereas a “repellent” is any compound, composition or combination capable of repelling or deterring one or more pests. Attractants may be used as a bait or lure in a trap. As used herein, a “bait” or “lure” is any compound, composition combination, object or chemically treated object capable of attracting one or more pests to a trap.

Regardless of directionality, an objective of the present invention is the delivery, by way of an unmanned aerial delivery vehicle, of compounds, compositions and methods which ameliorate, reduce, or eliminate the deleterious effects on human (or animal) health caused by pests, especially vector pests. Delivery can be made to areas that are generally difficult to access, such as remote areas (e.g., remote bodies of water). The compounds, compositions and/or combinations are useful for the prevention of vector-borne illnesses in individuals, groups of individuals or large populations as well as the spread of said illnesses. As used herein, the term “vector-borne illness” refers to any disease or period of sickness affecting a subject that is promoted, caused, or prolonged by direct or in-direct contact with a vector pest. Vector-borne illnesses (e.g., mosquito-borne illnesses) may include, but are not limited to malaria, Dengue fever, yellow fever, sleeping sickness, West Nile virus infection, Eastern equine encephalitis, river blindness, lymphatic filariasis, leishmaniasis, epidemic polyarthritis, Australian encephalitis, Zika virus infection and the like.

Zika virus is a virus that is primarily spread by mosquito bite (e.g., Aedes mosquito species). Once infected, pregnant women can pass the virus to their fetus. Zika virus infection during pregnancy can cause certain birth defects, including, but not limited to neurological defects, for example, microcephaly.

As used herein, a “pest” refers to any one of a number of species that cause harm, irritation, discomfort or general annoyance to humans or other animals. “Vector pests” are pests capable of carrying and/or transmitting a viral, bacterial, protozoan or other pathogens from reservoir to host. In some embodiments, vector pests are insects.

Insect vector pests may be arthropod insects and may be hematophagous. Pests or vector pests may also include biting insects. Pests which are of the order Hemiptera may include, but are not limited to assassin bugs of the subfamily Triatominae (including, but not limited to members of the genus Melanolestes, Platymeris, Pselliopus, Rasahus, Reduvius, Sinea, Triatoma and Zelus) and bed bugs of the genus Cimex (including, but not limited to Cimex lectularius). Pests which are fleas of the order Siphonaptera may include, but are not limited to members of the genus Ctenocephalides (including, but not limited to Ctenocephalides felis and Ctenocephalides canis), Pulex (including, but not limited to Pulex irritans), Dasypsyllus, Nosopsyllus and Xenopsylla. Pests which are of the order Ixodida may include, but are not limited to ticks of the family Nuttalliellidae (including Nuttalliella namaqua), Ixodidae (including, but not limited to Ixodes scapularis, Ixodes holocyclus, Ixodes hexagonus, Ixodes pacificus, Ixodes ricinus and Ixodes uriae) and Argasidae. Pests which are lice of the order Phthiraptera may include, but are not limited to members of the genus Pediculus (including, but not limited to Pediculus humanus capitis and Pediculus humanus humanus) and members of the genus Pthirus (including, but not limited to Pthirus pubis). Pests which are of the order Diptera, including flying dipterans (the term “flying dipterans” as used herein refers to any members of the order Diptera that are capable of flight) may include, but are not limited to, members of the mosquito family Culicidae (including, but not limited to members of the genus Aedeomyia, members of the genus Aedes (including, but not limited to Aedes aegypti), members of the genus Anopheles (including, but not limited to Anopheles gambiae and Anopheles annulipes), members of the genus Armigeres, members of the genus Ayurakitia, members of the genus Bironella, members of the genus Borichinda, members of the genus Chagasia, members of the genus Coquillettidia, members of the genus Culex (including, but not limited to Culex quinquefasciatus, Culex molestus, Culex annulirostris and Culex australicus), members of the genus Culiseta, members of the genus Deinocerites, members of the genus Eretmapodites, members of the genus Ficalbia, members of the genus Galindomyia, members of the genus Haemagogus, members of the genus Heizmannia, members of the genus Hodgesia, members of the genus Isostomyia, members of the genus Johnbelkinia, members of the genus Kimia, members of the genus Limatus, members of the genus Lutzia, members of the genus Malaya, members of the genus Mansonia, members of the genus Maorigoeldia, members of the genus Mimomyia, members of the genus Onirion, members of the genus Opifex, members of the genus Orthopodomyia, members of the genus Psorophora, members of the genus Runchomyia, members of the genus Sabethes, members of the genus Shannoniana, members of the genus Topomyia, members of the genus Toxorhynchites, members of the genus Trichoprosopon, members of the genus Tripteroides, members of the genus Udaya, members of the genus Uranotaenia, members of the genus Verrallina, members of the genus Wyeomyia and members of the genus Zeugnomyia), Tsetse flies of the genus Glossina (including, but not limited to Glossina austeni, Glossina morsitans, Glossina pallidipes Glossina swynnertoni, Glossina fusca fusca, Glossina fuscipleuris, Glossina frezili, Glossina haningtoni, Glossina longipennis, Glossina medicorum, Glossina nashi, Glossina nigrofusca nigrofusca, Glossina severini, Glossina schwetzi, Glossina tabaniformis, Glossina vanhoofi, Glossina caliginea, Glossina fuscipes fuscipes, Glossina fuscipes martinii, Glossina pallicera pallicera, Glossina pallicera newsteadi, Glossina palpalis palpalis, Glossina palpalis gambiensis and Glossina tachinoides), biting midges of the family Ceratopogonidae (including, but not limited to members of the genus Culicoides (including, but not limited to Culicoides sonorensis), members of the genus Leptoconops (including, but not limited to Leptoconops albiventris and Leptoconops torrens) and members of the genus Forcipomyia), black flies of the family Simuliidae (including, but not limited to members of the genus Simulium (including, but not limited to Simulium damnosum, Simulium neavei, Simulium callidum, Simulium metallicum, Simulium ochraceum, Simulium colombaschense, Simulium pruinosum and Simulium posticatum) and sand flies (including but not limited to members of the genus Lutzomyia (including, but not limited to Lutzomyia longipalpis) and members of the genus Phlebotomus (including, but not limited to Phlebotomus papatasi)).

### Definitions

Aerial delivery vehicle: As used herein, the term “aerial delivery vehicle” refers to any aerial vehicle capable of attachment with at least one delivery structure of the invention.

Attachment section: As used herein, the term “attachment section” refers to the part of a delivery structure used to affix the delivery structure to a vehicle (e.g., aerial vehicle).

Cargo holder: As used herein, the term “cargo holder” refers to a device used to hold a delivery unit in place. Cargo holders may be independent of releasing units or may be part of releasing units. In some cases, cargo holders are cargo rings (e.g., ring shaped cargo holders that encircle delivery units). In some cases, cargo holders are released along with delivery units and may be comprised of biodegradable materials (e.g., wood, paper, starch based plastic or other organic material).

Delivery structure: As used herein, the term “delivery structure” refers to a piece of equipment that attaches to a vehicle (e.g., an aerial vehicle) and that can hold and release at least one payload.

Delivery system: As used herein, the term “delivery system” refers to a delivery vehicle fitted with a delivery structure. Delivery systems of the invention include systems for aerial delivery of a payload (e.g., a pest control compound or composition).

Holding rack: As used herein, the term “holding rack” refers to a frame used to attach one or more delivery units, in some cases through attachment to releasing units.

In the field: As used herein, the term “in the field” refers to activities carried out beyond sites of manufacturing or development of the invention. In some cases, activities carried out in the field include activities carried out at a site (or area near or adjacent to such a site) where devices of the invention may be used or where methods of the invention may be used.

Releasing unit: As used herein, the term “releasing unit” refers to a device that can hold and release a payload in response to some form of trigger (e.g., actuation by a remote user, altitude threshold, sensor activation, timed release or any other form of automatic or manual actuation known to those of skill in the art).

Rotorcraft: As used herein, the term “rotorcraft” refers to an aerial vehicle that uses rotary wings or rotary blades to provide lift. Rotorcraft with multiple rotary wings are referred to herein as multirotorcraft.

Target area: As used herein, the term “target area” refers to any site or region where one or more delivery units are provided for any purpose. Target areas may be on land, in water, in the air or atmosphere, or in space. Target areas may be precise locations or may comprise one or more regions that may be of any size. In some embodiments, target areas are bodies of water. Target areas may further be defined by certain characteristics (e.g., in cases where target areas include any areas of pest habitation or reproduction). In some embodiments, target areas may include a subject population (e.g., a population of humans). In other embodiments, target areas may be adjacent to or utilized by a subject population. This may include bodies of water, e.g., bodies of water used for recreational purposes.

I. Delivery Systems

Provided herein are delivery systems comprising delivery structures attached to delivery vehicles (e.g., aerial delivery vehicles).

Delivery Structures

In embodiments of the present invention, there is provided delivery structures for aerial deployment of payloads (e.g., pest control compounds or compositions) to target areas. Delivery structures may comprise an attachment section for attaching delivery structures to an aerial delivery vehicle, and one or more delivery units adapted for containing and releasing payloads to target areas.

Attachment Section

In some embodiments, the attachment section of the delivery structure is adapted for attachment to one or more unmanned aerial vehicles. The attachment section can take various forms, which will be apparent to the person of skill in the art, and the specific form to be adopted will depend on the aerial vehicle(s) to which attachment is to be made. In some embodiments the attachment section is designed to be removable from the aerial vehicle following attachment.

The attachment section may also comprise one or more spacer elements for attaching the holding rack, the spacer elements providing, e.g., a separation between the attachment section and the holding rack. In one embodiment the one or more spacer elements may be present to facilitate the operation of attaching the delivery structure to the aerial delivery vehicle. The spacer elements may also be used to place the holding rack at a specific location in relation to the aerial delivery vehicle, which may be desired e.g. to avoid interaction between the delivery units and parts of the aerial delivery vehicle, or to improve the flight characteristics of the aerial delivery vehicle fitted with the delivery structure, for example by shifting the center of gravity of the vehicle to a more desired position.

Delivery Units

As used herein, the term “delivery unit” refers to a payload and includes any surrounding housing or other materials associated with the payload or used to prepare and/or contain the payload. The delivery units of the delivery structure may be adapted to a variety of payload types. As used herein, a “payload” refers to any compound, composition, material, supply, and/or equipment being delivered by a delivery vehicle of the invention. In one embodiment, payloads are pest control compounds or compositions, and delivery units provide for the delivery thereof to a target area. In some embodiments, delivery units may comprise payloads useful for purposes that are not related to pest control. In some cases, payloads may comprise supplies (e.g., food, water, materials, medical supplies, rescue supplies or kits, and/or equipment) to assist one or more persons in a remote location. In some cases, payloads may include other unmanned (autonomous or remotely piloted) vehicles (aerial or land-based). In some cases, payloads are robotic units or sensors. In some cases, payloads are messages. The delivery structure can contain one or more delivery units, and in some embodiments the delivery structure comprises a plurality of delivery units, e.g. 2, 3, 4, 5, 6, 7, 8, 9, 10 or more delivery units. In some embodiments, delivery structures may be designed to comprise from about 10 to about 50, from about 20 to about 100, from about 50 to about 500, or from about 200 to 1000 delivery units. In other embodiments, delivery structures may be designed to carry more than 1000 delivery units.

The delivery units can take any shape that is suitable for holding the payload, and they can for example be in the form of a cylinder, a cyclinder with rounded ends, a sphere, a cube, or a rectangular, triangle, hexagonal, or octagonal prism. Other suitable forms will be known to the person of skill in the art.

In some embodiments, delivery unit release from a delivery structure is independently actuated so as to control the number and/or type of delivery unit delivered to the target area. By independently actuated is meant that release of one or more of the delivery units may be actuated independently of the release of one or more other delivery units present in the delivery structure. Actuation of delivery unit release can, for example, cause the delivery unit to change orientation.

Actuation of delivery unit release from a delivery structure may be controlled by a remote operator or automated system, e.g. by way of a wireless signal, such as a radio wave, or it may be autonomous, controlled by a processor and memory unit present in the vehicle or delivery structure. Actuation of delivery unit release may also be powered or it may be passive. By powered is meant that a motor, spring, tensioned element, or equivalent thereof, moves the actuated elements, e.g. effects delivery unit release or effects the change in orientation of the delivery unit. By passive is meant that control of the actuation (e.g. by an operator or autonomously) releases movement of articulated sections of releasing units, i.e. allows articulated sections to move freely, the movement of the articulated sections then being directed by gravity or the movement of the aerial delivery vehicle.

In other embodiments, delivery unit release is carried out through actuation of a releasing unit attached to a delivery structure. Such release may be independent of adjacent releasing units, e.g., one or more of the delivery units may be released independently of one or more other delivery units present in the delivery structure. In some cases, delivery units may be released from left to right, right to left, outermost delivery units to innermost delivery units, or innermost delivery units to outermost delivery units. In some cases, release order may be altered to ensure the best weight distribution possible to minimize the impact to aerial delivery vehicle stability, altitude or momentum. In some cases, two or more delivery units may be released at the same time or all delivery units may be released at the same. In one embodiment, the delivery units that are releasable are constructed of a material that is environmentally safe and/or biodegradable.

In one embodiment, the delivery units comprise one or more housings. Housings may be in layers. Inner most housing layers (e.g., those adjacent to the payload) are referred to herein as “inner housings” or “capsules.” Housing layers enclosing the payload capsule are referred to herein as “outer housings.” Housing layers may be constructed of a material that breaks upon physical contact to disperse the payload on, into, or around the target area. Breaking open of such housing layers may occur due to force generated from impact after dropping from a certain elevation. In some cases, housing layers may break open due to a chemical, non-chemical, or mechanical trigger. Suitable housing materials will be known to the person of skill in the art, and may include, but are not limited to glass, plastic material, organic materials, gelatin, bags, balloons, paper, starch based plastics, and wood. These materials will have physical characteristics and a thickness that result in compromised structural integrity of the housing when dropped from a predetermined elevation.

In another embodiment, the delivery unit comprises a housing that has one or more openings through which the payload (e.g. pest control compounds or compositions) can escape into the target location. The housing can, for example, have openings of a size small enough to retain the payload during flight, but large enough to allow entry of water into the housing once delivered to the target area, permitting dissolution or degradation of the payload to effect subsequent escape thereof from the housing. In one embodiment, the housing can be in the form of a wire structure and the payload can be in the form of a particulate or encapsulated product that has a dimension that is too large to pass through the holes formed by the wire structure. In some cases, upon exposure to water, the particulate or the compound/composition held within the capsule will dissolve and escape into the target area.

In still another embodiment, the delivery unit comprises a housing that is partially or completely constructed of a material that degrades sufficiently, upon exposure to the environment at the target area, to provide delivery of the payload, found therein, to the target area. The housing may comprise a material that, upon contact with water, oxygen, or other environment, chemically reacts to dissolve or degrade, thereby releasing the payload. In such an embodiment, the delivery unit housing may be completely or partially constructed of such a dissolvable or degradable material.

In some embodiments, payload release from delivery units is electronic. Such electronic actuation may be triggered by contact with water.

In some embodiments, delivery units are solids, delivered without housing materials. Such delivery units may comprise hardened cakes of compounds or compositions that may be provided in brick or other solid format.

In some embodiments, actuation or release of the delivery units may be controlled by a remote operator or remote autonomous system, for example by way of radio waves. Actuation or release may also be controlled autonomously by way of a processor and memory unit present in the aerial delivery vehicle or delivery structure, based on predetermined conditions such as a specific location and/or altitude of the aerial delivery vehicle.

In some embodiments, the delivery units are adapted to contain and release payloads comprising a liquid, a solid, a slurry, pellets, aggregates, powder, or any combination thereof. In another embodiment, the payload is in the form of an encapsulated product (i.e., encapsulated by the inner housing). The encapsulation may be complete or partial, i.e. the payload may be fully encapsulated, or the inner housing forming the encapsulation may have one or more openings. The encapsulated payload may facilitate the loading of the delivery units and/or their delivery at the target location. The inner housing forming the encapsulated product may also be selected to provide for a timed, extended, or controlled release of the payload (e.g., the pest control compound or composition) to the target area. In one embodiment, the inner housing comprises a material which deteriorates or dissolves upon exposure to the environment, e.g. water, wind, or heat, at the target area, allowing for release of the payload (e.g., pest control compound or composition). For example, the inner housing may comprise gelatin. The thickness of such housings may be varied to control the length of exposure time required to release payloads. Inner housing thickness may be from about 5 μm to about 20 μm, from about 10 μm to about 50 μm, from about 25 μm to about 75 μm, from about 0.6 mm to about 1.2 mm, from about 0.75 mm to about 1.50 mm, from about 1 mm to about 10 mm, from about 2 mm to about 20 mm, from about 5 mm to about 50 mm, from about 10 mm to about 100 mm, from about 20 mm to about 60 mm, from about 30 mm to about 70 mm, from about 50 mm to about 200 mm, from about 100 mm to about 500 mm, from about 0.25 cm to about 0.75 cm and from about 0.5 cm to about 1 cm thick.

Some payloads may be present within water soluble packets. Such packets may dissolve on contact with water. In some cases, such packets may be made with rice paper or other water soluble materials.

In some embodiments, payloads within a capsule may comprise layers. In some cases, a payload layer may be capped on one or both ends by a cap layer. As used herein, the term “cap layer” refers to a material or substance that forms a wall or barrier adjacent to or near a payload inside of a capsule. Cap layers may be inner cap layers or outer cap layers. Inner cap layers form a barrier to payload movement toward the inside of a capsule. Outer cap layers form a barrier to payload movement out of a capsule. In some cases, cap layers are dissolvable. In some cases, cap layers may be comprised of a material that can undergo a chemical reaction when reaching a target area. Such chemical reactions may give off gasses that may alter delivery unit movement, buoyancy, or expel payload from the delivery unit. In some cases, cap materials react with water to dissolve and/or give off gas. Some cap layers may comprise ALKA-SELTZER® (Bayer Healthcare, LLC, Whippany, N.J.).

In some embodiments, delivery units may comprise one or more buoyancy pocket. As used herein, the term “buoyancy pocket” refers to a pocket within a delivery unit that may be varied in size and/or content to affect floatation of delivery units or capsules in liquid (e.g., water). For floating delivery units, buoyancy pockets may be filled with gas. In sinking delivery units, buoyancy pockets may be filled with heavy solids, such as sand or metal. In some cases, buoyancy pockets are rigid structures. In other cases, buoyancy pockets may expand (e.g., with a balloon or latex frame that expands). In some cases, buoyancy pockets may fill with gas after contact with a target area or liquid within a target area. In one example, delivery units may comprise chemicals that produce gas when water is contacted, leading to accumulation of gas in buoyancy pockets and resulting in delivery unit floatation. In some cases, buoyancy pocket contents, size or structure are modified to provide delivery units to a preferred depth in a body of water or other liquid. Buoyancy pockets may also be used to orient delivery units in water (e.g., to ensure an opening for payload escape remains submerged).

Delivery units may comprise additional features to promote payload dispersion. Such features may include payload ejection devices (e.g., a spring-loaded ejection device). In some cases, payload ejection devices cause delivery units to burst or explode to disperse payload. Payload ejection devices may be actuated in response to certain stimuli, including, but not limited chemical, non-chemical, electronic, or physical stimuli (e.g., impact force). Electronic stimuli may comprise remote actuation by an operator or autonomous system. In some cases, electronic stimuli may involve the use of a resistor or battery that may short circuit upon delivery unit impact or contact with water (e.g., through a water soluble fusible link). Physical stimuli may include, but are not limited to, contact with an object or target area, or contact with water.

Delivery units designed for payload delivery to a body of water may comprise a dispersion indicator, such as a fluorescent dye, to enable visualization of payload dispersion. Dispersion indicators may be packed into delivery units as a layer adjacent to the payload or may be mixed with one or more payload compounds.

Aerial delivery vehicles of the invention may be used to deliver payloads to harsh environments. As used herein, a “harsh environment” is a place where it may be difficult or impossible for humans to enter (e.g., caves; rain forests; over building fires or forest fires; areas with toxic gases, chemicals or radioactivity; an industrial mining or drilling site, or areas with extreme weather conditions). In some cases, such payloads are sensors (e.g., pH sensors, sensors for the detection of gasses, etc.).

Delivery units may be of any weight and weight may be varied depending on the payload and the type of aerial delivery vehicle used to deliver such delivery units. Delivery unit weights may be measured using any metric of weight, including, but not limited to pounds (lbs), grams (g), kilograms (kg), ounces (ozs), etc. In some cases, delivery units are from about 0.01 lbs to about 0.5 lbs, from about 0.02 lbs to about 1.0 lbs, from about 0.7 lbs, to about 2.0 lbs, from about 1.5 lbs, to about 5 lbs, or from about 3 lbs to about 10 lbs. In some cases, delivery units may be more than 10 lbs. In other embodiments, delivery units may be from about 0.1 g to about 1 g, from about 0.5 g to about 2 g, from about 1 g to about 5 g, from about 2 g to about 10 g, from about 3 g to about 15 g, from about 5 g to about 25 g, from about 10 g to about 50 g, from about 15 g to about to about 45 g, from about 25 g to about 75 g, from about 30 g to about 60 g, from about 50 g to about 100 g, from about 75 g to about 150 g, from about 100 g to about 500 g, from about 200 g to about 1 kg, from about 300 g to about 600 g, from about 500 g to about 2 kg, from about 750 g to about 1.5 kg, from about 1 kg to about 5 kg, from about 2 kg to about 10 kg, from about 3 kg to about 6 kg, from about 5 kg to about 25 kg, from about 10 kg to about 50 kg, or more than 50 kg.

Delivery units may also be designed to have any desired volumes. Volumes within any housing layers (inner housings or outer housings) may be from about 0.1 ml to about 1 ml, from about 0.5 ml to about 2 ml, from about 1 ml to about 5 ml, from about 2 ml to about 10 ml, from about 3 ml to about 15 ml, from about 5 ml to about 25 ml, from about 10 ml to about 50 ml, from about 15 ml to about to about 45 ml, from about 25 ml to about 75 ml, from about 30 ml to about 60 ml, from about 50 ml to about 100 ml, from about 90 ml to about 150 ml, from about 100 ml to about 500 ml, from about 200 ml to about 1 L, from about 300 ml to about 600 ml, from about 500 ml to about 2 L, from about 750 ml to about 1.5 L, from about 1 L to about 5 L, from about 2 L to about 10 L, from about 3 L to about 6 L, from about 5 L to about 25 L, from about 10 L to about 50 L, or more than 50 L.

### Holding Rack

In some embodiments, the delivery structure may also comprise a holding rack on which may be held the delivery units. In one embodiment, the holding rack may be attached to the attachment section and/or spacer elements of the delivery structure. The holding rack may be adapted to facilitate loading and/or unloading of the delivery units, or to facilitate loading of payloads (e.g., pest control compounds or compositions) into the delivery units. The holding rack may also be designed for the attachment of one or more releasing units to effect the actuation or release of the delivery units.

In some embodiments, the attachment section, spacer elements, holding rack, releasing units, cargo holders and delivery units may also be articulated so as to provide different spatial arrangements between the attachment section and the delivery units. In some embodiments, the articulation may provide benefits in attaching or removing the delivery structure from the aerial delivery vehicle, in introducing the payload into the delivery units, and/or in fixing the delivery units to the delivery structure and/or holding rack. In some embodiments the articulation may provide two or more arrangements of attachment section, spacer elements, holding rack, releasing units, cargo holders, and/or delivery units, which arrangements have different air drag profiles for the aerial delivery vehicle when in flight, providing a first arrangement of elements to be used when in flight, and a second arrangement to be used when delivering the payload to the target area. The articulation may also provide an arrangement of the attachment section, spacer elements, holding rack, releasing units, cargo holders, and/or delivery units which facilitates landing of the aerial delivery vehicle, e.g. by providing improved clearance for landing gear. The articulations between the elements may be powered, e.g. by way of a motor. Movement of the articulated elements may also be controlled by a remote operator, a remote autonomous system, or autonomously by a processor and memory unit on the aerial delivery vehicle.

The various components of the delivery structure (e.g. the attachment section, spacer elements, holding rack, releasing units, cargo holders, and/or delivery units), may be made of any material or materials that provide sufficient strength to maintain attachment during use. The materials may be selected to balance this sufficient strength with a lower weight, for example to maximize the weight of payload that can be transported at one time by the aerial delivery vehicle. In some embodiments, suitable materials for the components of the delivery structure include steel, aluminum, titanium, carbon fiber, fiberglass, Kevlar, and other polymeric materials. Portions of the delivery structure may also have a composite structure, such as a foam or honeycomb core optionally covered by an outer sheeting, e.g. of the above suitable materials.

Delivery structures of the invention may be designed for quick assembly and/or modification, e.g., by someone working in the field. Such structures may be comprised of components that are easily attached and detached. For example, delivery structures may be modified in the field to replace a holding rack with another holding rack selected in the field (e.g., to accommodate a different number or type of delivery unit). Further structures may allow for multiple configurations to conform to a desired function. For example, the holding rack may be shifted in position in relation to the attachment section to alter the center of gravity of the delivery structure. Similarly, releasing units may be shifted in position relative to the holding rack. In some cases, alternative numbers, shapes, and sizes of cargo holders may be used to adapt to delivery unit length, width and/or weight. In some cases, delivery structures may be exchanged in the field. Such methods may allow someone working in the field to quickly adapt an aerial delivery vehicle for a specific purpose without modification of individual delivery structures.

In some embodiments, delivery structures may also be easily transferable between different types of aerial delivery vehicles. In some cases, such structures may have magnetic attachment sections that can be quickly transferred from one vehicle type to the next. In some cases, attachment section may be equipped with flexible hooks or clips that are capable of attaching the delivery structure to multiple vehicle types.

Delivery Vehicles

Delivery vehicles of the invention may be any vehicles capable of carrying a delivery structure and delivering one or more delivery units to a target area. In some embodiments, delivery vehicles are aerial delivery vehicles.

Aerial delivery vehicles may include any powered, aerial vehicle that can be piloted remotely. In some cases, aerial delivery vehicles use aerodynamic forces to provide vehicle lift. In one embodiment, the aerial delivery vehicle is a rotorcraft, for example a multirotorcraft having, e.g., 4, 6 or 8 rotors.

Suitable aerial delivery vehicles will be known to the person of skill in the art. In some embodiments, the aerial delivery vehicle is the Spreading Wings S900 hexacopter from DJI, weighing about 7.3 lbs. In some embodiments, similar aerial delivery vehicles may be used with air frame weights of from about 2 lbs to about 50 lbs. In some embodiments, aerial delivery vehicles weigh more than 50 lbs, e.g., from about 50 lbs to about 200 lbs, from about 100 lbs to about 500 lbs, from about 300 lbs to about 700 lbs, from about 500 lbs to about 1000 lbs, from about 750 lbs to about 1500 lbs, from about 1000 lbs to about 2000 lbs, or at least 2000 lbs.

In some embodiments, the aerial delivery vehicle contains a wireless network interface to permit operation from a remote operator or remote autonomous system. In one embodiment remote operation is effected by way of radio waves. In some embodiments, the aerial delivery vehicle contains a processor and a memory unit that provide autonomous flight control of the aerial delivery vehicle and/or autonomous control of the actuation or release of the delivery units.

In some embodiments, the aerial delivery vehicle comprises one or more video cameras and is able to transmit video images in real time. The one or more video cameras may have a fixed orientation, or they may be provided on a pivoted support which provides rotation of the one or more video cameras on one or more axis. In one embodiment, the one or more video cameras provide first person viewing for pilot viewing and/or drop zone viewing (i.e. a view of the target area to which the payload is to be delivered). Suitable video cameras and pivoted supports will be known to the person of skill in the art. The one or more video cameras can be, for example, a video camera provided by GoPro, such as a GoPro Hero 4 Black. The pivoted support can be a gimbal, such as those provided by Zenmus, e.g. a Zenmus H3-3D.

In some embodiments, the aerial delivery vehicle may comprise a global positioning system (GPS). The aerial delivery vehicle may also transmit the GPS coordinates of the aerial delivery vehicle to the remote operator or remote autonomous system. In one embodiment, the remote autonomous system may be programmed to provide automated flight and/or payload delivery instructions to the aerial delivery vehicle, for example providing waypoints to be followed by the aerial delivery vehicle based on GPS coordinates.

In some embodiments, aerial delivery vehicles may be piloted autonomously. In some cases, autonomous piloting may be coordinate-based. In some cases, aerial delivery vehicles may comprise a GPS, a processor and a memory device, which components may provide an autopilot system to the aerial delivery vehicle. For example, the autopilot system may, upon receipt of a wireless signal from the remote operator or autonomous system, initiate a predetermined flight plan. This flight plan can, for example, result in the vehicle gaining a predetermined altitude and then flying to a predetermined location, e.g. a home position, based on the GPS coordinates of the aerial delivery vehicle and the GPS coordinates of the predetermined location. In another embodiment, the autopilot system may be programmed such that if no wireless signals are received from a remote operator or remote autonomous system for a predetermined length of time, the autopilot system may initiate an automatic hover mode and/or the system may calculate and initiate a flight plan to return the vehicle to a predetermined location, e.g. a home position. The autopilot system may also affect automatic landing of the aerial delivery vehicle at a predetermined location.

Aerial delivery vehicles of the invention may be used at various velocities and maneuvering speeds depending on the application. Aerial delivery vehicle velocities and maneuvering speeds may be measured using any distance/time metric including, but not limited to, meters/second (m/s) and miles/hour (mph). In some embodiments, aerial delivery vehicles of the invention may operate at least 1 m/s, at least 5 m/s, at least 10 m/s, at least 15 m/s, at least 20 m/s, at least 25 m/s, at least 50 m/s, at least 100 m/s, or at least 200 m/s.

In some embodiments, aerial delivery vehicles of the invention may be battery powered. Battery weights may be varied depending on the size of the vehicle as well as desired velocities and maneuvering speeds. In some cases, aerial delivery vehicle batteries are from about 0.05 lbs to about 10 lbs.

In some cases, aerial delivery vehicles of the invention may be equipped with lighting systems. Such lighting systems may include, but are not limited to LED lighting systems. In some cases, LED lighting systems may include differently colored lights to indicate front and back aerial delivery vehicle direction (e.g., green and red lights).

In some cases, delivery vehicles may comprise on board electronics that could receive and/or transmit a signal indicating successful dispersion of a payload. Such signals may be transmitted by electronics associated with a delivery unit.

### II. Pest Control Payloads

In some embodiments, payloads of the invention comprise compounds or compositions capable of modulating pest population levels and/or pest host detection. Such compounds or compositions may include any of those known to those of skill in the art. In some cases, such compounds or compositions capable of modulating pest population levels and/or pest host detection may fall into certain categories according to different structural and chemical properties. These categories may include, but are not limited to aromatic compounds, pyrazine ring-containing compounds, furan ring-containing compounds, ketones, aldehydes, acetates, essential oils, environmentally safe compounds, flavoring agents and odorants. Compounds may include, but are not limited to any of those listed in Table 1.

TABLE 1
Pest Control Compounds

| APP ID | Compound |
|---|---|
| X0001 | 2,4-lutidine |
| X0002 | 2-ethylpyrazine |
| X0003 | 2-methoxypyrazine |
| X0004 | 2-methyltetrahydrofuran-3-one |
| X0005 | 4-ethylphenol |
| X0006 | 5-methyl furfural |
| X0007 | butyl formate |
| X0008 | cyclopentanone |
| X0009 | ethyl 2-furoate |
| X0010 | ethyllactate |
| X0011 | ethylvinylcarbinol |
| X0012 | guaiacol |
| X0013 | trans-2-methyl-2-butenal |
| X0014 | 2,3,5-trimethylpyrazine |
| X0015 | 2,3-dimethylpyrazine |
| X0016 | 2-acetyl-5-methyl furan |
| X0017 | 2-furyl methyl ketone |
| X0018 | 2-pentanone |
| X0019 | allyl butyrate |
| X0020 | cinnamyl nitrile |
| X0021 | ethyl 3-hydroxyhexanoate |
| X0022 | ethylacetoacetate |
| X0023 | ethylvinylketone |
| X0024 | gamma-heptalactone |
| X0025 | methanethiol acetate |
| X0026 | methyl crotonate |
| X0027 | methyl levulinate |
| X0028 | phenylacetaldehyde |
| X0029 | phenylpropylaldehyde |
| X0030 | 2,4-dimethyl benzaldehyde |
| X0031 | 2,4-dimethyl-3-cyclohexene- |
| | carboxaldehyde (mixture of cis/trans |
| | forms) |
| X0032 | 2-ethyl-5(6)-methylpyrazine |
| X0033 | 2-methoxy-4-methylphenol |
| X0034 | 2-phenylpropionaldehyde |
| X0035 | 3-hexanone |
| X0036 | 4-ethylbenzaldehyde |
| X0037 | 4-oxoisophorone |
| X0038 | acetyl-2-pyrazine |
| X0039 | butan-3-one-2yl butanoate |
| X0040 | dimethyl succinate |
| X0041 | dipropylenglycol-monomethyl ether |
| X0042 | ethyl 3-hydroxybutyrate |
| X0043 | ethyl-2,3,5(6)-dimethyl pyrazine |
| X0044 | ethylformate |
| X0045 | ethylisobutyrate |
| X0046 | ethylisovalerate |
| X0047 | ethyllevulinate |
| X0048 | furfurylethylether |
| X0049 | heptaldehyde |
| X0050 | heptanone-4 |
| X0051 | hexanal |
| X0052 | indole |
| X0053 | isobutyl acetate |
| X0054 | isobutyl propionate |
| X0055 | isobutyl trans-2-butenoate |
| X0056 | isopropyl butyrate |
| X0057 | isopropyl tiglate |
| X0058 | methyl isovalerate |
| X0059 | methyl heptadienone |
| X0060 | m-tolualdehyde |
| X0061 | o-anisaldehyde |
| X0062 | prenylacetate |
| X0063 | propyl formate |
| X0064 | R-+ pulegone |
| X0065 | trans-cinnamaldehyde |
| X0066 | valeraldehyde |
| X0067 | 2,3-diethyl-5-methylpyrazine |
| X0068 | 2,3-diethylpyrazine |
| X0069 | 2-ethyl-3-methylpyrazine |
| X0070 | 2-methoxy-3-methylpyrazine |
| X0071 | 2-ethyl-3-methoxypyrazine |
| X0072 | 2-methoxy-3(5or6) isopropylpyrazine |
| X0073 | cis-3-hexenyl acetate |
| X0074 | furfurylpentanoate |
| X0075 | octanone-3 |
| X0076 | phenethyl propionate |
| X0077 | trans-2-decenal |
| X0078 | (Z)-hept-3-enylacetate (Violana) |
| X0079 | 1-ethylhexyl tiglate |
| X0080 | 1-octanol |
| X0081 | 2,5-dimethyl-4-methoxy-3(2H) furanone |
| X0082 | alpha,alpha-dimethyl phenethyl butyrate |
| X0083 | cis-3-hexenyl butyrate |
| X0084 | cis-5-octen-1-ol |
| X0085 | ethyl nicotinate |
| X0086 | ethylheptanoate |
| X0087 | Eucalyptol |
| X0088 | furfurylpentenoate |
| X0089 | geranylacetone |
| X0090 | geranylbutyrate |
| X0091 | methyl heptanoate |
| X0092 | methyl amyl ketone |
| X0093 | rosemary oil |
| X0094 | whiskey lactone |
| X0095 | Veratraldehyde |
| X0096 | cis-3-hexenyl formate |
| X0097 | hexyl formate |
| X0098 | isoamyl formate |
| X0099 | isoamyl propionate |
| X0100 | methyl (E)-hex-3-enoate |
| X0101 | peppermint oil |
| X0102 | Eugenol |
| X0103 | phenethyl cinnamate |
| X0104 | allyl cinnamate |
| X0105 | trans-cinnamyl propionate |
| X0106 | cinnamic aldehyde dimethyl acetal |
| X0107 | cinnamyl formate |
| X0108 | cinnamyl isobutyrate |
| X0109 | cinnamyl propionate |
| X0110 | ethyl cinnamate |
| X0111 | menthalactone |
| X0112 | methoxy cinnamic aldehyde |
| X0113 | methyl cinnamate |
| X0114 | methyl trans-cinnamate |
| X0115 | Menthol |
| X0116 | salicylaldehyde |
| X0117 | 2-nonanone |
| X0118 | Ultrazur |
| X0119 | hexyl butyrate |
| X0120 | pyrazine |
| X0121 | p-Tolyl acetate |
| X0122 | methyl propionate |
| X0123 | phenethyl formate |
| X0124 | phenethyl acetate |
| X0125 | 1-octen-3-yl acetate |
| X0126 | octyl butyrate |
| X0127 | linalool |
| X0128 | 5,6,7,8-tetrahydroquinozaline |
| X0129 | 4-(3-phenylpropyl)pyridine |
| X0130 | 1,3-diphenyl-2-propanone |
| X0131 | decahydro-2-napthol |
| X0132 | mehtyl 2-pyrroly ketone |
| X0133 | 2-isobutyl-3-methoxypyrazine |
| X0134 | 2-acetylpyridine |
| X0135 | 2-methoxy-3-(1-methylpropyl) pyrazine |
| X0136 | 2-acetylcyclopentanone |
| X0137 | celery ketone |
| X0138 | 1-heptanol |
| X0139 | trans-2-octenal |
| X0140 | lactic acid |
| X0141 | trans-2-undecenal |
| X0142 | 6-methyl-5-hepten-2-one |
| X0143 | trans-2-nonenal |
| X0144 | allyl pelargonate |
| X0145 | methyl dihydrojasmonate |
| X0146 | isomenthone DL |
| X0147 | phenethyl butyrate |
| X0148 | ethyl trans-2-buteonate |
| X0149 | methyl jasmonate |
| X0150 | L-menthone |
| X0151 | 2-methylbutyraldehyde |
| X0152 | 2,3-pentanedione |
| X0153 | 2,6-dimethylpyrazine |
| X0154 | farnesal |
| X0155 | beta pinene |
| X0156 | 4-acetoxy-2,5-dimethyl-3(2H) Furanone |
| X0157 | methyl acetate |
| X0158 | delta-hexalactone |
| X0159 | gamma-hexalactone |
| X0160 | 2-acetyl-3,5(6)-dimethylpyrazine |
| X0161 | 2-ethoxy-3-ethylpyrazine |
| X0162 | 2-acetyl-3-methylpyrazine |
| X0163 | 3,4-hexanedione |
| X0164 | 2,3-hexanedione |
| X0165 | damascenone |
| X0166 | 3-nonanone |
| X0167 | gamma-valerolactone |
| X0168 | 2-methylcyclohexanone |
| X0169 | benzyl cinnamate |
| X0170 | tetrahydrofurfuryl acetate |
| X0171 | benzyl formate |
| X0172 | propyl butyrate |
| X0173 | propyl propionate |
| X0174 | 2′-hydroxyacetophenone |
| X0175 | 3,5-dimethyl-1,2-cyclopentadione |
| X0176 | 4-phenyl-3-buten-2-one |
| X0177 | 2-ethyl-1-butanol |
| X0178 | 5-methyl-3-hexen-2-one |
| X0179 | 3,5-dimethyl-1-hexyn-3-ol |
| X0180 | 4-methyl-2-pentanone |
| X0181 | 5-methyl-2-hepten-4-one |
| X0182 | 4,4-dimethoxy-2-butanone |
| X0183 | 3-methyl-2-pentanone |
| X0184 | delta-octalactone |
| X0185 | alpha methylbenzyl propionate |
| X0186 | 3-decen-2-one |
| X0187 | 2-methyl-3(5 OR 6)-ethoxypyrazine |
| X0188 | 2-ethylfenchol |
| X0189 | 3-methyl-2-cyclohexenone |
| X0190 | anisole |

Pyrazine compounds—compounds and compositions are disclosed herein containing components with one or more pyrazine ring structures. Pyrazine rings can be formed through the pyrolysis of natural amino acid precursors including serine and threonine in the presence of sugars such as glucose and fructose (Teranishi, R., Flavor Chemistry: Thirty Years of Progress, Springer, 1999). They are found in a variety of food items, especially those processed at elevated temperatures in the absence of water.

Furan compounds—compounds and compositions are disclosed herein containing components with one or more furan ring structures. Many of these compounds can be found in nature or are synthetic chemicals closely resembling those in nature. Furans themselves are cyclic and contain the formula C₄H₄O. They are often used as the starting point for chemical synthesis of other compounds.

Essential oils—compounds and compositions are disclosed herein that contain essential oils and/or compounds derived from essential oils. The term “essential oil” as used herein refers to any volatile aromatic liquid extracted from plants. Typically these compounds carry a distinctive scent of the plant from which they were extracted. Extraction is typically carried out by distillation allowing for extraction of concentrated compounds. Essential oils of the present invention include, but are not limited to rosemary oil, eucalyptol, peppermint oil and eugenol. Essential oils also include cinnamon oil, clove oil, mint oil, jasmine oil, geraniol, camphor oil, hinoki oil, sage oil, tohi oil, pomegranate oil, rose oil, turpentine oil, bergamot oil, mandarin oil, pine oil, calamus oil, lavender oil, bay oil, hiba oil, lemon oil, thyme oil, menthol, cineole, citral, citronella, linalool, borneol, camphor, thymol, spilanthole, pinene, terpene, limonene and the like. It is known in the art that some essential oils or combinations thereof, have repellent and/or attractant properties with regard to insects.

Eugenol (X0102) is a phenolic essential oil found at high levels in clove oil and is known to have strong antimicrobial and insecticidal activity. Interestingly, it can also act as an attractant for some insects, such as Japanese beetles. Its presence on the list of FIFRA exempt compounds makes it an attractive candidate for use in insecticides, repellents or lures.

Peppermint oil is extracted from the peppermint plant, a hybrid of watermint and spearmint. It is currently used in natural pesticides due to the presence of menthone, a known repellent agent.

Rosemary oil is extracted from the rosemary plant. It has a strong aroma and is a natural component of some pesticides.

Guaiacol is a natural compound and a component of wood-tar creosote. It is aromatic and has been used medicinally as an antipyretic, antiseptic and expectorant. In some embodiments, compounds and/or compositions of the present invention comprise guaiacol.

Lemon eucalyptus is a natural plant oil extracted from the leaves of lemon eucalyptus trees [Maia and Moore, Malaria Journal 2011, 10 (Suppl 1)]. The oil contains p-menthane 3, 8-diol, (PMD) which is an insect repellant against a broad range of insect vectors. Lemon eucalyptus is approved for skin application according to the Environmental Protection Agency (EPA) and can be applied to skin and used against mosquitoes, biting flies and gnats (Katz et al. 2008. J. Am Acad. Dermat. 58(5): 865-71). The use of lemon eucalyptus as an insect repellent has been described in U.S. Pat. No. 7,846,464, U.S. Pat. No. 6,284,227 and U.S. Pat. No. 8,501,205 and in a U.S. patent publication US 2013/0084347, the contents of each of which are hereby incorporated by reference in their entirety. Lemon eucalyptus is also used in antiseptic, antibiotic, antifungal, bactericidal and antiviral compositions, as described in U.S. Pat. No. 7,872,051 and U.S. Pat. No. 7,189,421, the contents of each of which are hereby incorporated by reference in their entirety. Lemon eucalyptus is also used in tea, as described in U.S. Pat. No. 5,578,338, the contents of which are hereby incorporated by reference in their entirety. In some embodiments, lemon eucalyptus is used in combination with one or more compounds of the invention. In some cases, such combinations have synergistic effects with regard to modulation of pest behavior (e.g. repelling pests).

Picaridin (1-piperidinecarboxylic acid 2-(2-hydroxyethyl)-1-methylpropylester, KBR 3023, Icaridin), is an odorless compound commonly used as an ingredient in insect repellents. Picaridin (Bayer, Leverkusen, Germany) is a synthetic molecule and is part of the piperidine chemical family. It is effective against mosquitoes, biting flies and ticks (Katz et al. 2008. J. Am Acad. Dermat. 58(5): 865-71). The compound does not leave a sticky or greasy feeling and is less likely to irritate skin. Picaridin is EPA approved for skin application. Picaridin can also be applied to many surfaces as it does not damage plastics or fabrics. The use of picaridin in pest control and as an insect repelling ingredient is described in U.S. Pat. No. 7,744,911 and U.S. patent publications US 2012/0237466, US 2012/0150355 and US 2007/0264294, the contents of each of which are hereby incorporated by reference in their entirety. In some embodiments, picardin is combined with one or more compounds of the invention. In some cases, such combinations have synergistic effects with regard to modulation of pest behavior (e.g. repelling pests).

IR3535 (3-[N-Butyl-N-acetyl]-aminopropionic acid; Merck, Kenilworth, N.J.) is a synthetic insect repellant inspired by natural plant oils. IR3535 is approved for skin application according to the Environmental Protection Agency (EPA) (Katz et al. 2008. J. Am Acad. Dermat. 58(5): 865-71) and may be applied to human skin and clothing to repel biting arthropods such as mosquitoes, flies and ticks (WHO Specifications and Evaluations for Public Health Pesticides, IR3535, 2006). The use of IR3535 as an insect repellent component has been described in U.S. Pat. No. 6,969,521, U.S. Pat. No. 8,795,699, U.S. Pat. No. 7,150,878 and U.S. Pat. No. 6,159,452 and in U.S. patent publications US 2006/0067965 and US 2011/0104224, the contents of each of which are hereby incorporated by reference in their entirety. In some embodiments, IR3535 is combined with one or more compounds of the invention. In some cases, such combinations have synergistic effects with regard to modulation of pest behavior (e.g. repelling pests).

In some cases, compounds recited herein may be used in combination with one or more other compounds. In some embodiments, compounds may act synergistically in combination to affect pest CO₂ response and/or biocidal activity. Combinations may include, but are not limited to any of those listed in Table 2.

TABLE 2
Combinations

| Combination | Compound | Compound | Compound |
|---|---|---|---|
| No. | 1 | 2 | 3 |
| Z0001 | X0007 | X0001 | |
| Z0002 | X0017 | X0020 | |
| Z0003 | X0027 | X0025 | |
| Z0004 | X0020 | X0014 | |
| Z0005 | X0022 | X0020 | |
| Z0006 | X0020 | X0015 | |
| Z0007 | X0020 | X0024 | |
| Z0008 | X0078 | X0102 | X0071 |
| Z0009 | X0074 | X0071 | X0102 |
| Z0010 | X0100 | X0068 | X0071 |
| Z0011 | X0068 | X0102 | X0080 |
| Z0012 | X0013 | X0001 | |
| Z0013 | X0068 | X0102 | X0078 |
| Z0014 | X0008 | X0011 | |
| Z0015 | X0068 | X0071 | X0074 |
| Z0016 | X0102 | X0074 | |
| Z0017 | X0068 | X0071 | X0072 |
| Z0018 | X0027 | X0019 | |
| Z0019 | X0020 | X0029 | |
| Z0020 | X0100 | X0068 | X0102 |
| Z0021 | X0068 | X0069 | |
| Z0022 | X0071 | X0072 | |
| Z0023 | X0102 | X0095 | |
| Z0024 | X0067 | X0070 | |
| Z0025 | X0071 | X0073 | |
| Z0026 | X0102 | X0083 | |
| Z0027 | X0024 | X0029 | |
| Z0028 | X0002 | X0001 | |
| Z0029 | X0071 | X0075 | |
| Z0030 | X0016 | X0029 | |
| Z0031 | X0013 | X0011 | |
| Z0032 | X0017 | X0016 | |
| Z0033 | X0017 | X0015 | |
| Z0034 | X0017 | X0014 | |
| Z0035 | X0016 | X0024 | |
| Z0036 | X0093 | X0102 | |
| Z0037 | X0072 | X0071 | X0102 |
| Z0038 | X0092 | X0017 | |
| Z0039 | X0024 | X0019 | |
| Z0040 | X0072 | X0071 | X0080 |
| Z0041 | X0080 | X0102 | X0071 |
| Z0042 | X0072 | X0071 | X0078 |
| Z0043 | X0027 | X0026 | |
| Z0044 | X0100 | X0016 | |
| Z0045 | X0006 | X0011 | |
| Z0046 | X0006 | X0008 | |
| Z0047 | X0068 | X0067 | |
| Z0048 | X0008 | X0001 | |
| Z0049 | X0100 | X0071 | |
| Z0050 | X0102 | X0084 | |
| Z0051 | X0076 | X0071 | |
| Z0052 | X0102 | X0078 | |
| Z0053 | X0016 | X0014 | |
| Z0054 | X0011 | X0004 | |
| Z0055 | X0006 | X0013 | |
| Z0056 | X0015 | X0019 | |
| Z0057 | X0074 | X0071 | X0072 |
| Z0058 | X0102 | X0082 | |
| Z0059 | X0102 | X0080 | |
| Z0060 | X0006 | X0004 | |
| Z0061 | X0100 | X0068 | X0074 |
| Z0062 | X0006 | X0007 | |
| Z0063 | X0006 | X0010 | |
| Z0064 | X0102 | X0089 | |
| Z0065 | X0006 | X0001 | |
| Z0066 | X0006 | X0002 | |
| Z0067 | X0016 | X0021 | |
| Z0068 | X0007 | X0011 | |
| Z0069 | X0013 | X0003 | |
| Z0070 | X0013 | X0002 | |
| Z0071 | X0100 | X0068 | X0080 |
| Z0072 | X0010 | X0003 | |
| Z0073 | X0010 | X0001 | |
| Z0074 | X0100 | X0068 | X0072 |
| Z0075 | X0092 | X0024 | |
| Z0076 | X0002 | X0011 | |
| Z0077 | X0003 | X0011 | |
| Z0078 | X0071 | X0077 | |
| Z0079 | X0093 | X0089 | |
| Z0080 | X0068 | X0070 | |
| Z0081 | X0008 | X0003 | |
| Z0082 | X0071 | X0074 | |
| Z0083 | X0100 | X0068 | X0078 |
| Z0084 | X0008 | X0002 | |
| Z0085 | X0008 | X0004 | |
| Z0086 | X0002 | X0003 | |
| Z0087 | X0013 | X0004 | |
| Z0088 | X0076 | X0074 | |
| Z0089 | X0093 | X0084 | |
| Z0090 | X0015 | X0014 | |
| Z0091 | X0006 | X0003 | |
| Z0092 | X0013 | X0008 | |
| Z0093 | X0076 | X0072 | |
| Z0094 | X0007 | X0003 | |
| Z0095 | X0007 | X0002 | |
| Z0096 | X0076 | X0077 | |
| Z0097 | X0015 | X0024 | |
| Z0098 | X0015 | X0028 | |
| Z0099 | X0100 | X0014 | |
| Z0100 | X0100 | X0024 | |
| Z0101 | X0015 | X0100 | |
| Z0102 | X0015 | X0021 | |
| Z0103 | X0014 | X0024 | |
| Z0104 | X0014 | X0028 | |
| Z0105 | X0014 | X0018 | |
| Z0106 | X0024 | X0021 | |
| Z0107 | X0024 | X0028 | |
| Z0108 | X0024 | X0018 | |
| Z0109 | X0021 | X0028 | |
| Z0110 | X0021 | X0018 | |
| Z0111 | X0002 | X0004 | |
| Z0112 | X0003 | X0004 | |
| Z0113 | X0010 | X0008 | |
| Z0114 | X0010 | X0007 | |
| Z0115 | X0010 | X0013 | |
| Z0116 | X0010 | X0004 | |
| Z0117 | X0010 | X0002 | |
| Z0118 | X0010 | X0011 | |
| Z0119 | X0007 | X0008 | |
| Z0120 | X0007 | X0004 | |
| Z0121 | X0008 | X0022 | |
| Z0122 | X0017 | X0022 | |
| Z0123 | X0022 | X0016 | |
| Z0124 | X0022 | X0015 | |
| Z0125 | X0022 | X0014 | |
| Z0126 | X0022 | X0024 | |
| Z0127 | X0022 | X0021 | |
| Z0128 | X0022 | X0028 | |
| Z0129 | X0022 | X0018 | |
| Z0130 | X0099 | X0014 | |
| Z0131 | X0099 | X0017 | |
| Z0132 | X0097 | X0014 | |
| Z0133 | X0097 | X0024 | |
| Z0134 | X0097 | X0017 | |
| Z0135 | X0096 | X0024 | |
| Z0136 | X0096 | X0017 | |
| Z0137 | X0098 | X0014 | |
| Z0138 | X0098 | X0024 | |
| Z0139 | X0098 | X0022 | |
| Z0140 | X0098 | X0017 | |
| Z0141 | X0018 | X0063 | |
| Z0142 | X0027 | X0020 | |
| Z0143 | X0027 | X0014 | |
| Z0144 | X0027 | X0029 | |
| Z0145 | X0027 | X0015 | |
| Z0146 | X0027 | X0022 | |
| Z0147 | X0027 | X0021 | |
| Z0148 | X0027 | X0024 | |
| Z0149 | X0027 | X0018 | |
| Z0150 | X0091 | X0025 | |
| Z0151 | X0008 | X0063 | |
| Z0152 | X0168 | X0017 | |
| Z0153 | X0121 | X0017 | |
| Z0154 | X0168 | X0021 | |
| Z0155 | X0168 | X0016 | |
| Z0156 | X0168 | X0029 | |
| Z0157 | X0168 | X0024 | |
| Z0158 | X0168 | X0014 | |
| Z0159 | X0168 | X0025 | |
| Z0160 | X0168 | X0019 | |
| Z0161 | X0168 | X0020 | |
| Z0162 | X0168 | X0015 | |
| Z0163 | X0168 | X0098 | |
| Z0164 | X0168 | X0042 | |
| Z0165 | X0168 | X0027 | |
| Z0166 | X0168 | X0026 | |
| Z0167 | X0168 | X0165 | |
| Z0168 | X0168 | X0099 | |
| Z0169 | X0166 | X0017 | |
| Z0170 | X0168 | X0022 | |
| Z0171 | X0168 | X0125 | |
| Z0172 | X0168 | X0028 | |
| Z0173 | X0168 | X0097 | |
| Z0174 | X0168 | X0121 | |
| Z0175 | X0168 | X0118 | |
| Z0176 | X0168 | X0096 | |
| Z0177 | X0121 | X0022 | |
| Z0178 | X0121 | X0024 | |
| Z0179 | X0121 | X0027 | |
| Z0180 | X0168 | X0091 | |
| Z0181 | X0164 | X0071 | |
| Z0182 | X0124 | X0071 | |
| Z0183 | X0126 | X0081 | |
| Z0184 | X0108 | X0085 | |
| Z0185 | X0072 | X0187 | |
| Z0186 | X0072 | X0078 | |
| Z0187 | X0072 | X0125 | |
| Z0188 | X0075 | X0187 | |
| Z0189 | X0072 | X0185 | |
| Z0190 | X0072 | X0081 | |
| Z0191 | X0072 | X0079 | |
| Z0192 | X0072 | X0094 | |
| Z0193 | X0189 | X0026 | |
| Z0194 | X0189 | X0025 | |
| Z0195 | X0189 | X0168 | |
| Z0196 | X0166 | X0025 | |
| Z0197 | X0189 | X0017 | |
| Z0198 | X0189 | X0024 | |
| Z0199 | X0189 | X0022 | |
| Z0200 | X0189 | X0014 | |
| Z0201 | X0189 | X0121 | |
| Z0202 | X0189 | X0019 | |
| Z0203 | X0189 | X0027 | |
| Z0204 | X0165 | X0025 | |
| Z0205 | X0189 | X0099 | |
| Z0206 | X0189 | X0028 | |
| Z0207 | X0189 | X0091 | |
| Z0208 | X0189 | X0029 | |
| Z0209 | X0189 | X0015 | |
| Z0210 | X0189 | X0165 | |
| Z0211 | X0189 | X0016 | |
| Z0212 | X0165 | X0017 | |

### Formulation Synergists

In some embodiments of the present invention, the smell of repellent and/or attractant compounds and/or compositions of the present invention may be modified with a synergist. Such modification may be carried out to affect sensation of such compounds and/or compositions by one or more subjects (e.g. subjects to be protected from vector pests) being exposed to such compounds and/or compositions. As such, attractant and/or repellent compounds and/or compositions may be combined with one or more synergist. As used herein, the term “synergist” refers to an agent (or combination of agents) that modulates overall efficacy and/or odor when combined with one or more compound or included in one or more composition. Synergists may comprise a particular odor or fragrance or may impart an odor or fragrance upon combination with one or more compounds and/or composition. In some cases, synergists may be used to make the overall odor of a composition more acceptable to one or more subjects exposed to such compositions while enhancing efficacy. In some cases, synergists may include, but are not limited to Aldehyde C11 (Undecylenic Aldehyde); Aldehyde iso C11 (GIV); Allspice oil; Allyl cyclohexyl propionate; Amyl salicylate; Amylcinnamic aldehyde; Anethole; Anisic alcohol; Anisic aldehyde; Applinal (Q); Bay oil; Benzyl acetate; Benzyl benzoate; Benzyl cinnamate; Benzyl propionate; Benzyl salicylate; Bourgeonal (Q); Brahmanol; Camphor powder synthetic; Cedarwood Virginian; Cedrenol; Cedryl acetate; Celestolide (IFF); Cineole; Cinnamic alcohol; cinnamic aldehyde; Cinnamon Leaf Oil: Cinnamyl acetate; cis-3-Hexenol; Citral; Citronella oil; Citronellal; Citronellol; Citronellyl acetate; Citronellyl oxyacetaldehyde; Clove oil; Coriander oil; Coumarin; Cuminic aldehyde; Cyclamen aldehyde; Decanal; 9-Decenol; Dibenzyl ether; Dibutyl phthalate; Diethyl Phthalate; Dihydromyrcenol; Dimethyl anthranilate; Dimethyl phthalate; Dimycretol (IFF); diphenylmethane; Diphenyl oxide; Dimethyl benzyl carbinyl acetate; Dodecanol; Dodecanal; Elemi oil; Ethyl methyl phenyl glycidate; Ethyl cinnamate; Ethyl safranate (Q); ethyl vanillin; Eugenol; Evergreen oils (Pine oils etc.); gamma-Nonalactone; gamma-decalactone; gamma-undecalactone; Geraniol; Geranium bourbon; Geranyl acetate; Geranyl formate; Gum Benzoin; Heliotropin; Hercolyn D (HER); Hexyl benzoate; Hexylcinnamic aldehyde; Hydratropic aldehyde dimethyl acetal; Hydroxycitronellal; Hydroxycitronellal dimethyl acetal; Indole; iso Bomyl acetate; Isopropyl myristate; Iso-cyclocitral (GIV, IFF); Jasmacyclene; Jasmin oil; Lavandin Abrialis; Lavender oil; Lilial (GIV); Linalol; Linalyl acetate; Menthol Laevo; Methyl anthranilate; Methyl cedryl ketone; Methyl dihydrojasmonate; Methyl ionone; Methyl myristate; Methyl naphthyl ketone; Methyl salicylate; Moss treemoss; Musk ketone; Nerol; Nerolin Bromelia; Neryl acetate; Nonanal; Oakmoss absolute; Octanol Olibanum resionoid; para-Cresyl phenylacetate; para-Methoxyacet6-phenone; Patchouli oil; Peppermint oil; Petitgrain oil; 2-Phenoxyethanol; Phenoxyethyl iso butyrate; Phenylethylacetate; Phenyethyl alcohol; Phenylethyl butyrate; Phenylethyl phenylacetate; Pimento oil; Pinene, alpha; Para-tert-butyl-cyclohexyl acetate; Resinoid Benzoin Siam; Rose oil; Rosemary oil; Sandalwood oil; terpineol; Tetrahydrolinalol; Tetrahydromuguol (IFF); Thyme Red; Undecanal; Vanillin; Verbena oil; Vetyvert Bourbon; Yara and Ylang ylang, acidic mucopolysaccharides and their salts, Aesculus hipocastanum, aloe barbadenisis Mil (Aloe Vera Linne), .alpha.-hydroxycarboxylic acids, .alpha.-ketocarboxylic acids, amide derivatives, amino acids, amphiphilic cyclodextrin derivatives, .beta.-sitosterol, carboxy vinyl polymer water soluble salts, carboxymethyl cellulose, carrageenan, chitin, chitosan, cholesterol, cholesterol fatty acid ester, collagen, dicarboxylic acid monostearyl esters, di-fatty acid glycerol esters, digalactosyl diglyceride, ersterol, ethanol, extract of Swertia japonica Makino, fatty acids, fatty acid citrate esters, fatty alcohols, ginseng extract, glucose esters of higher fatty acids, guar gum, gum arabic, Hamamelidaceae (Hamamelis Virginiana Witch hazel), hyaluronic acid, hydrochyloesterol, hydroxybenzoic acids, isomaltose, isopropyl alcohol, lactose, lanosterol, lipids extracted from the biomass of microorganisms, yeasts, moulds and bacteria, liposomes, locust bean gum, low molecular acidic mucopolysaccharides and their salts, low molecular weight humectant components, maltose, mineral oils, mineral powders, mono cis alkenoic acid, mucopolysaccharides, mycosterol, N-acyl lysines, N-isostearyl lysine, N-lauroyl lysine, N-myristyl lysine, N-palmitoyl lysine, N-stearoyl lysine, natrium type bentonite, natural or synthetic aminoacid with protein or peptide bonds, NMF ingredients, nonvolatile silicones, oil agents, oil matter, oligosaccharides, organic acids, pantothenic acid and its derivatives, petroleum jelly, phosphatidyl ethanolamine, phosphatidylcholine, phospholipids, polysaccharides, polyvinyl alcohol, polypeptides, proteins, raffinose, saponins, sodium hyaluronate, sources of linoleic acid, sterols, sterol esters, stigmasterol, sucrose, sugar esters of higher fatty acids, sulphatide, sunscreens, surfactants, talc, thymosterol, tocopherol, mono-, di- or tri-glycerides, vitamins and analogues, vitamin E and/or its ester compounds, volatile silicone fluids, water-soluble moisture-retaining agents, water-soluble polymers and waxes. In some cases, synergists may include, but are not limited to any of the flavoring agents and/or fragrant compounds discussed by Fahlbusch et al (Fahlbusch et al., 2003. Flavors and Fragrances. Ullmann's Encyclopedia of Industrial Chemistry, the contents of which are herein incorporated by reference in their entirety.).

### Carbon Dioxide (CO₂) Response or Activity Targeting

It is known that female mosquitoes track vertebrate blood-meals primarily through carbon dioxide (CO₂) emissions in exhaled breath and skin odor emissions (Gillies M. T., The role of carbon dioxide in host-finding by mosquitoes (Diptera: Culicidae): a review. Bull. Entomology Res. 1980. 70:525-532 and Tauxe, G. M. et al., 2013. Cell. 155:1365-79.). CO₂ is sensed in specialized neurons in the mosquito maxillary palp that express heteromeric CO₂-receptor proteins, highly conserved across the order Diptera. Studies utilizing electrophysiology and behavior assays have demonstrated that certain small molecules can stimulate or inhibit the CO₂ receptor (Turner, S. L. et al., Ultra prolonged activation of CO₂-sensing neurons disorients mosquitoes. Nature. 2011 Jun. 2; 474(7349):87-91). Recent studies have also shown that the CO₂ receptor plays an important role in the detection of skin odors. Such molecules that inhibit the CO₂ receptor are currently being explored in the field as mosquito deterrents (or repellents), while molecules that stimulate mosquito CO₂ receptor activity are attractive targets for use in insect traps. It is also the case that strong and prolonged activators of CO₂ receptor activity can have a “masking” effect, with concomitant repellent outcomes, because prolonged activation would saturate the CO₂ receptor signaling, thereby rendering the mosquito unable to track CO₂ plumes. In this situation, even CO₂ receptor activators would be considered repellents for purposes of reducing their contact with subjects (e.g. humans and other animals, including but not limited to cattle, horses, cats, dogs, and pigs) and their areas of habitation.

In some embodiments, compounds and compositions of the present invention may activate, saturate and/or inhibit the activity of CO₂-responsive neurons, the receptors of which are conserved across different species of pests and are expressed by neurons in the antennae or maxillary palp. As used herein, a “CO₂ receptor” is a receptor or other cellular protein capable of sensing, binding or otherwise responding to CO₂ or to changes in CO₂ levels. A “CO₂-responsive neuron” is a neuron capable of directly sensing CO₂ or responds to changes in CO₂ levels and in which activity correlates with those levels.

As used herein, “neuronal activity” refers to cellular impulses that can be detected using electrophysiological methods.

In one embodiment, the compounds and compositions disclosed are activators of CO₂-responsive neurons. As used herein, an “activator” is any compound, composition or combination capable of stimulating neuronal activity in CO₂-responsive neurons. Activators may alter pest behavior in varying ways and as such may act as attractants or inhibitors depending on the application.

Activation, measured in spikes per second (spk/sec), may be reflected in an activity of by about 20-300 spikes per second (spk/sec), by about 20-200 spk/sec, by about 20-100 spk/sec, by about 20-80 spk/sec, by about 20-60 spk/sec, by about 20-40 spk/sec, by about 40-300 spk/sec, by about 40-200 spk/sec, by about 40-100 spk/sec, by about 40-80 spk/sec, by about 40-60 spk/sec, by about 60-300 spk/sec, by about 60-200 spk/sec, by about 60-100 spk/sec, by about 60-80 spk/sec, by about 100-300 spk/sec or by about 100-200 spk/sec. A “spike” refers to an impulse of neuronal activity as recorded through extracellular single-sensillum electrophysiology.

Activators are divided into mild, moderate, strong and very strong. A “mild activator” is a compound, composition or combination that is able to directly activate CO₂-responsive neurons resulting in a spike rate of 20-40 spk/sec over the baseline activity of the neuron. A “moderate activator” is a compound, composition or combination that is able to directly activate CO₂-responsive neurons resulting in a spike rate of 40-60 spk/sec over the baseline activity of the neuron. A “strong activator” is a compound, composition or combination that is able to directly activate CO₂-responsive neurons resulting in a spike rate of 60-100 spk/sec over the baseline activity of the neuron. A “very strong activator” is a compound, composition or combination that is able to directly activate CO₂-responsive neurons resulting in a spike rate of over 100 spk/sec over the baseline activity of the neuron.

Where activators are delivered in saturating concentrations to the effect of producing a repellent response, these compounds, compositions or combinations are referred to as “masking” agents. Masking agents, therefore may also be termed repellents or deterrents.

In some embodiments, activator compounds may comprise any of those listed in Table 3.

TABLE 3
Activator Compounds

| Compound | |
|---|---|
| No. | Compound |
| X0001 | 2,4-lutidine |
| X0002 | 2-ethylpyrazine |
| X0003 | 2-methoxypyrazine |
| X0004 | 2-methyltetrahydrofuran-3-one |
| X0005 | 4-ethylphenol |
| X0006 | 5-methyl furfural |
| X0007 | butyl formate |
| X0008 | cyclopentanone |
| X0009 | ethyl 2-furoate |
| X0010 | ethyllactate |
| X0011 | ethylvinylcarbinol |
| X0012 | guaiacol |
| X0013 | trans-2-methyl-2-butenal |
| X0014 | 2,3,5-trimethylpyrazine |
| X0015 | 2,3-dimethylpyrazine |
| X0016 | 2-acetyl-5-methyl furan |
| X0017 | 2-furyl methyl ketone |
| X0018 | 2-pentanone |
| X0019 | allyl butyrate |
| X0020 | cinnamyl nitrile |
| X0021 | ethyl 3-hydroxyhexanoate |
| X0022 | ethylacetoacetate |
| X0023 | ethylvinylketone |
| X0024 | gamma-heptalactone |
| X0025 | methanethiol acetate |
| X0026 | methyl crotonate |
| X0027 | methyl levulinate |
| X0028 | phenylacetaldehyde |
| X0029 | phenylpropylaldehyde |
| X0030 | 2,4-dimethyl benzaldehyde |
| X0031 | 2,4-dimethyl-3-cyclohexene- |
| | carboxaldehyde (mixture of cis/trans |
| | forms) |
| X0032 | 2-ethyl-5(6)-methylpyrazine |
| X0033 | 2-methoxy-4-methylphenol |
| X0034 | 2-phenylpropionaldehyde |
| X0035 | 3-hexanone |
| X0036 | 4-ethylbenzaldehyde |
| X0037 | 4-oxoisophorone |
| X0038 | acetyl-2-pyrazine |
| X0039 | butan-3-one-2yl butanoate |
| X0040 | dimethyl succinate |
| X0041 | dipropylenglykol-monomethyl ether |
| X0042 | ethyl 3-hydroxybutyrate |
| X0043 | ethyl-2,3,5(6)-dimethyl pyrazine |
| X0044 | ethylformate |
| X0045 | ethylisobutyrate |
| X0046 | ethylisovalerate |
| X0047 | ethyllevulinate |
| X0048 | furfurylethylether |
| X0049 | heptaldehyde |
| X0050 | heptanone-4 |
| X0051 | hexanal |
| X0052 | indole |
| X0053 | isobutyl acetate |
| X0054 | isobutyl propionate |
| X0055 | isobutyl trans-2-butenoate |
| X0056 | isopropyl butyrate |
| X0057 | isopropyl tiglate |
| X0058 | methyl isovalerate |
| X0059 | methylheptadienone |
| X0060 | m-tolualdehyde |
| X0061 | o-anisaldehyde |
| X0062 | prenylacetate |
| X0063 | propyl formate |
| X0064 | R-+ pulegone |
| X0065 | trans-cinnamaldehyde |
| X0066 | valeraldehyde |
| X0120 | pyrazine |
| X0121 | p-Tolyl acetate |
| X0122 | methyl propionate |
| X0123 | phenethyl formate |
| X0124 | phenethyl acetate |
| X0158 | delta-hexalactone |
| X0159 | gamma-hexalactone |
| X0167 | gamma-valerolactone |
| X0168 | 2-methylcyclohexanone |
| X0170 | tetrahydrofurfuryl acetate |
| X0171 | benzyl formate |
| X0172 | propyl butyrate |
| X0173 | propyl propionate |
| X0174 | 2′-hydroxyacetophenone |
| X0175 | 3,5-dimethyl-1,2-cyclopentadione |
| X0176 | 4-phenyl-3-buten-2-one |
| X0177 | 2-ethyl-1-butanol |
| X0178 | 5-methyl-3-hexen-2-one |
| X0179 | 3,5-dimethyl-1-hexyn-3-ol |
| X0180 | 4-methyl-2-pentanone |
| X0181 | 5-methyl-2-hepten-4-one |
| X0182 | 4,4-dimethoxy-2-butanone |
| X0183 | 3-methyl-2-pentanone |
| X0184 | delta-octalactone |
| X0188 | 3-methyl-2-cyclohexenone |
| X0189 | anisole |

In one embodiment the compounds and compositions disclosed are inhibitors of CO₂-responsive neurons. As used herein, an “inhibitor” is any compound, composition or combination capable of reducing neuronal activity in CO₂-responsive neurons. Inhibitors may alter pest behavior in varying ways and as such may act as pest attractants or repellents depending on the application.

Inhibition, measured as relative reduction of activity, may be reflected in reduced activity of about 20-100%, by about 20-80%, by about 20-60%, by about 20-40%, by about 40-100%, by about 40-80%, by about 40-60%, by about 60-100% or by about 60-80%.

Inhibitors of the present invention are divided into mild, moderate and strong inhibitors. A “mild inhibitor” is a compound, composition or combination that is able to directly inhibit CO₂-responsive neuronal activity resulting in a 20-40% reduction in neuronal activity as compared to baseline activity of the neuron. A “moderate inhibitor” is a compound, composition or combination that is able to directly inhibit CO₂-responsive neuronal activity resulting in a 40-60% reduction in neuronal activity as compared to baseline activity of the neuron. A “strong inhibitor” is a compound, composition or combination that is able to directly inhibit CO₂-responsive neuronal activity resulting in a greater than 60% reduction in neuronal activity as compared to baseline activity of the neuron.

In some embodiments, inhibitor compounds may include, but are not limited to any of those listed in Table 4.

TABLE 4
Inhibitor Compounds

| Compound | |
|---|---|
| No. | Compound |
| X0067 | 2,3-diethyl-5-methylpyrazine |
| X0068 | 2,3-diethylpyrazine |
| X0069 | 2-ethyl-3-methylpyrazine |
| X0070 | 2-methoxy-3-methylpyrazine |
| X0071 | 2-ethyl-3-methoxypyrazine |
| X0072 | 2-methoxy-3(5or6) isopropylpyrazine |
| X0073 | cis-3-hexenyl acetate |
| X0074 | furfurylpentanoate |
| X0075 | octanone-3 |
| X0076 | Phenethyl propionate |
| X0077 | trans-2-decenal |
| X0078 | (Z)-hept-3-enylacetate |
| X0079 | 1-ethylhexyl tiglate |
| X0080 | 1-octanol |
| X0081 | 2,5-dimethyl-4-methoxy-3(2H) furanone |
| X0082 | alpha,alpha-dimethyl phenethyl butyrate |
| X0083 | cis-3-hexenyl butyrate |
| X0084 | cis-5-octen-1-ol |
| X0085 | ethyl nicotinate |
| X0086 | Ethylheptanoate |
| X0087 | Eucalyptol |
| X0088 | furfurylpentenoate |
| X0089 | Geranylacetone |
| X0090 | Geranylbutyrate |
| X0091 | methyl heptanoate |
| X0092 | methylamylketone |
| X0093 | rosemary oil |
| X0094 | whiskey lactone |
| X0095 | Veratraldehyde |
| X0125 | 1-octen-3-yl acetate |
| X0126 | octyl butyrate |
| X0117 | 2-nonanone |
| X0185 | alpha methylbenzyl propionate |
| X0186 | 3-decen-2-one |
| X0187 | 2-methyl-3(5 OR 6)-ethoxypyrazine |
| X0166 | 3-nonanone |
| X0188 | 2-ethylfenchol |

### Beta Activators

Three types of CO₂-responsive neurons reside in the maxillary palp of mosquitoes. These include cpA, cpB and cpC neurons. While activity from cpA neurons produces the largest amplitude spike during electrophysiological analysis, cpB and cpC neurons present in this region are responsive to passively emitted skin odors (Lu, T. et al., Odor coding in the maxillary palp of the malaria vector mosquito Anopheles gambiae. Curr Biol. 2007 Sep. 18; 17(18):1533-44. Epub 2007 Aug. 30). These neurons produce spikes with much lower amplitude than those produced by cpA neurons. Although the activity from cpB and cpC neurons cannot easily be distinguished from one another, their collective activity can be distinguished from cpA neurons due to their characteristic spikes. This is useful in the identification of compounds and compositions that only activate or inhibit cpB and cpC neurons or compounds and compositions that activate or inhibit both. As used herein, the term “beta activator” refers to any compound or composition that can stimulate cpB and cpC neuronal activity.

In some embodiments, beta activator compounds of the present invention may include, but are not limited to any of those listed in Table 5.

TABLE 5
Beta Activator Compounds

| Compound | |
|---|---|
| No. | Compound |
| X0096 | cis-3-hexenyl formate |
| X0097 | hexyl formate |
| X0098 | isoamyl formate |
| X0099 | isoamyl propionate |
| X0100 | methyl (E)-hex-3-enoate |
| X0101 | peppermint oil |
| X0074 | furfurylpentanoate |
| X0084 | cis-5-octen-1-ol |
| X0079 | 1-ethylhexyl tiglate |
| X0027 | methyl levulinate |
| X0125 | 1-octen-3-yl acetate |
| X0165 | damascenone |
| X0166 | 3-nonanone |

### Synergistic Components

It has been unexpectedly found that certain compounds recited herein, when combined, produce synergistic outcomes with regard to their ability to modulate pest population levels and/or pest behavior. For example, some combinations were found to be strong activators although comprising only mild or moderate activator compounds. Likewise, other combinations were found to be synergistic inhibitors although comprising only mild or moderate inhibitor compounds. In addition, synergistic combinations were identified which act as either activators or inhibitors despite comprising a compound that individually displayed the opposite function when applied as a single compound. In some cases, combinations of compounds may act synergistically with regard to biocidal activity, including, but not limited to larvicidal activity.

Biocidal and/or Lethal Compounds

Some compositions of the present invention may comprise biocidal agents, also referred to herein as “biocides.” As used herein, the term “biocidal agent” or “biocide” refers to any agent capable of killing a biological organism. In some embodiments, such organisms are pests. In some embodiments, such pests are vector pests (e.g. a flying dipteran, mosquito, sand fly, black fly, tsetse fly, biting midge, bed bug, assassin bug, flea, louse, mite or tick.) As used herein, the term “biocidal activity” refers to the killing capability of a given biocide. In some embodiments, biocides may be larvicides. As used herein, the term “larvicide” refers to an agent that exhibits biocidal activity toward one or more larvae. Such larvae may be pest larvae. In some cases, pest larvae comprise vector pest larvae (e.g. dipteran larvae, mosquito larvae or larvae from a sand fly, black fly, tsetse fly or biting midge.)

In some embodiments, biocides of the present invention are lethal. As used herein the term “lethal” is used to refer to any agent capable of causing death in one or more organisms that are exposed to such an agent. In some embodiments, such organisms are pests. In some embodiments, such pests are vector pests. As used herein, the term “lethality” refers to the capability of a given agent to cause death in one or more organisms exposed to such an agent.

In some embodiments, biocidal compounds and/or compositions of the present invention may comprise one or more of the compounds listed in Table 6.

TABLE 6
Biocidal Compounds

| Compound | |
|---|---|
| No. | Compound |
| X0005 | 4-ethylphenol |
| X0020 | cinnamyl nitrile |
| X0021 | ethyl 3-hydroxyhexanoate |
| X0029 | phenylpropylaldehyde |
| X0052 | Indole |
| X0076 | phenethylpropionate |
| X0077 | trans-2-decenal |
| X0079 | 1-ethylhexyl tiglate |
| X0084 | cis-5-octen-1-ol |
| X0102 | eugenol |
| X0103 | phenethyl cinnamate |
| X0104 | allyl cinnamate |
| X0105 | trans-cinnamyl propionate |
| X0106 | cinnamic aldehyde dimethyl acetal |
| X0107 | cinnamyl formate |
| X0108 | cinnamyl isobutyrate |
| X0109 | cinnamyl propionate |
| X0110 | ethyl cinnamate |
| X0111 | menthalactone |
| X0112 | methoxy cinnamic aldehyde |
| X0113 | methyl cinnamate |
| X0114 | methyl trans-cinnamate |

In some embodiments, combinations of compounds that may be used in biocidal applications may include, but are not limited to Z0002, Z0004, Z0006, Z0007, Z0008, Z0009, Z0011, Z0013, Z0016, Z0019, Z0020, Z0022, Z0023, Z0026, Z0027, Z0030, Z0036, Z0041, Z0050, Z0051, Z0052, Z0058, Z0059, Z0061, Z0064, Z0067, Z0071, Z0075, Z0078, Z0079, Z0082, Z0088, Z0089, Z0093, Z0096, Z0097, Z0106, Z0127, Z0133, Z0135, Z0136, Z0138, Z0142

Compositions with biocidal activity may comprise biocidal compounds at varying concentrations. In some embodiments, concentrations of biocidal compounds in such compositions may be measured in parts per million (ppm.) Some compositions may comprise from about 0.1 ppm to about 2 ppm, from about 1 ppm to about 10 ppm, from about 5 ppm to about 50 ppm, from about 50 ppm to about 150 ppm, from about 100 ppm to about 200 ppm, from about 200 ppm to about 500 ppm, from about 500 ppm to about 1000 ppm or at least 1000 ppm. In other embodiments, compositions may comprise biocidal compounds at concentrations of from about 0.1% to about 0.5%, from about 0.25% to about 1.5%, from about 1% to about 10%, from about 5% to about 20%, from about 10% to about 30%, from about 15% to about 35%, from about 20% to about 40%, from about 30% to about 50%, from about 40% to about 60%, from about 50% to about 75% or at least 75%. In still other embodiments, biocidal compounds may be present in biocidal compositions at concentrations of from about 0.01 mg/ml to about 0.1 mg/ml, from about 0.2 mg/ml to about 2 mg/ml, from about 1 mg/ml to about 4 mg/ml, from about 2 mg/ml to about 5 mg/ml, from about 5 mg/ml to about 10 mg/ml, from about 10 mg/ml to about 20 mg/ml, from about 15 mg/ml to about 30 mg/ml, from about 25 mg/ml to about 50 mg/ml, from about 40 mg/ml to about 60 mg/ml, from about 50 mg/ml to about 75 mg/ml, from about 70 mg/ml to about 100 mg/ml, from about 100 mg/ml to about 500 mg/ml, from about 500 mg/ml to about 1 g/ml or at least 1 g/ml.

In some embodiments, larvicidal compounds and/or compositions of the present invention may comprise one or more of the compounds listed in Table 7.

TABLE 7
Larvicidal Compounds

| Compound | |
|---|---|
| No. | Compound |
| X0001 | 2,4-lutidine |
| X0002 | 2-ethylpyrazine |
| X0003 | 2-methoxypyrazine |
| X0005 | 4-ethylphenol |
| X0006 | 5-methyl furfural |
| X0008 | cyclopentanone |
| X0009 | ethyl 2-furoate |
| X0011 | ethyl vinyl carbinol |
| X0012 | guaiacol |
| X0013 | trans-2-methyl-2-butenal |
| X0014 | 2,3,5-trimethylpyrazine |
| X0016 | 2-acetyl-5-methyl furan |
| X0017 | 2-furyl methyl ketone |
| X0019 | allyl butyrate |
| X0020 | cinnamyl nitrile |
| X0024 | gamma-heptalactone |
| X0025 | methanethiol acetate |
| X0026 | methyl crotonate |
| X0027 | methyl levulinate |
| X0028 | phenylacetaldehyde |
| X0029 | phenyl propyl aldehyde |
| X0052 | indole |
| X0059 | methyl heptadienone |
| X0065 | trans-cinnamaldehyde |
| X0066 | valeraldehyde |
| X0067 | 2,3-diethyl-5-methylpyrazine |
| X0068 | 2,3-diethylpyrazine |
| X0069 | 2-ethyl-3-methylpyrazine |
| X0070 | 2-methoxy-3-methylpyrazine |
| X0071 | 2-ethyl-3-methoxypyrazine |
| X0072 | 2-methoxy-3(5or6) isopropylpyrazine |
| X0073 | cis-3-hexenyl acetate |
| X0074 | furfuryl pentanoate |
| X0075 | octanone-3 |
| X0076 | phenethyl propionate |
| X0077 | trans-2-decenal |
| X0079 | 1-ethylhexyl tiglate |
| X0084 | cis-5-octen-1-ol |
| X0091 | methyl heptanoate |
| X0092 | methyl amyl ketone |
| X0096 | cis 3-hexenyl formate |
| X0097 | hexyl formate |
| X0100 | methyl (E)-hex-3-enoate |
| X0101 | peppermint oil |
| X0102 | eugenol |
| X0104 | allyl cinnamate |
| X0105 | trans-cinnamyl propionate |
| X0106 | cinnamic aldehyde dimethyl acetal |
| X0107 | cinnamyl formate |
| X0109 | cinnamyl propionate |
| X0110 | ethyl cinnamate |
| X0111 | menthalactone |
| X0112 | methoxy cinnamic aldehyde |
| X0113 | methyl cinnamate |
| X0114 | methyl trans-cinnamate |
| X0115 | menthol |
| X0116 | salicylaldehyde |
| X0108 | cinnamyl isobutyrate |
| X0118 | Ultrazur |
| X0119 | hexyl butyrate |

### Formulations

The compositions may be combined in formulations. As used herein, a “formulation” is a combination of one or more compounds or compositions prepared as per a formula and may include one or more excipients, carriers or delivery agents. Formulations may be dry or wet or may be solid or liquid. Formulations may be designed for one or more particular applications or uses. The formulations of the present invention are also compositions while compositions may be formulated.

Formulations of the compounds, compositions or combinations of the present invention may be deployed by aerosolization via sublimation, spray, vaporization, and the like. They may be deployed as solids such as blocks, rods, crystals, granules, pellets, beads, powders and the like for release of vapors over time. Said formulations may be designed for slow release.

In another embodiment, the compounds and compositions of the invention may be used in liquid form, either as purified liquids or in aqueous-based or non-aqueous (organic) formulations. As used herein the term “aqueous” means similar to or containing or dissolved in water, e.g., an aqueous solution. A “slurry” according to the present invention is a suspension of predominantly insoluble particles, usually in water. Suitable liquid diluents or carriers include water, petroleum distillates, or other liquid carriers. In one embodiment, said diluents further comprise surface active agents. Non-ionic, anionic, amphoteric, or cationic dispersing and emulsifying agents may be employed. The choice of liquid formulation components is dictated by the intended use of the composition, the desired distribution of the active compounds within the formulation and the ability of the formulation to be effectively spread across the desired treatment area. Said liquid formulations may be in the form of foams, gels, creams, mousse, suspensions, emulsions, microemulsions, emulsifiable concentrates, pastes and the like.

In one embodiment, formulations may be used as a repellent to repel pests from a given area.

In another embodiment, formulations may be activator formulations, employed to activate CO₂-responsive neuronal activity. In further embodiments, the activator formulations are utilized as attractants to draw pests to a given site or away from a less desired site. The site of attraction may be a trap or device deployed to capture or otherwise attract the pests. Compounds or compositions of the invention may be formulated with attractants known in the art. These attractant formulations may comprise one or more of the following: sugar, honey, molasses, plant oils, animal oils such as fish oil and the like, plant extracts, floral odors, pheromones, proteins, salt, seeds, animal feed, livestock feed, sticky agents, adhesives including substances such as tanglewood and the like. In another embodiment, activator formulations may be utilized as a protectant to prevent pest attraction to an individual or group of individuals within an area desired to be protected. These protectant formulations may act to overwhelm CO₂-responsive neurons in pests, rendering them unable to track CO₂ plumes exhaled from individuals or groups of individuals.

### Other Components of Formulations

Formulations containing compounds or compositions of the present invention may comprise further components depending upon the desired use of the formulation. These components include, but are not limited to carriers, thickeners, surface-active agents, preservatives, aromatics, deodorizers, and one or more of several types of adjuvant including, but not limited to, wetting agents, spreading agents, sticking agents, foam retardants, buffers and acidifiers. In another embodiment, the compounds and compositions of the present invention may be supplied as a concentrate which may be diluted to achieve a desired strength depending on the application. The term “concentrate” as used herein, refers to a compound or composition in condensed form. A concentrate therefore may contain some diluents and not necessarily be purified.

### Carriers

The compounds and compositions of the present invention may contain one or more carriers or carrier vehicles. These carriers may be gaseous, liquid or solid and are most often inert but may be active ingredients. Carrier vehicles may include, but are not limited to, aerosol propellants, such as freon, (present in a gaseous state at normal temperatures and pressures); inert dispersible liquid diluent carriers, including inert organic solvents, aromatic hydrocarbons (such as benzene, toluene, xylene, alkyl naphthalenes, etc.), halogenated especially chlorinated, aromatic hydrocarbons (such as chloro-benzenes, etc.), chlorinated aliphatic hydrocarbons (such as chloroethylenes, methylene chloride, etc.), cycloalkanes, (such as cyclohexane, etc.), paraffins (such as petroleum or mineral oil fractions), acetonitrile, ketones (such as cyclohexanone, methyl ethyl ketone, acetone, methyl isobutyl ketone, etc.), alcohols (such as ethanol, methanol, propanol, glycol, butanol, etc.) as well as ethers and esters thereof (such as glycol monomethyl ether, etc.), amides (such as dimethylformamide etc.), amines (such as ethanolamine, etc.), sulfoxides (such as dimethylsulfoxide, etc.), and/or water. Carriers may also include inert, finely divided solid carriers that may be dispersible such as ground natural minerals (including, but not limited to chalk, i.e. calcium carbonate, silica, alumina, vermiculite, talc, kieselguhr, attapulgite, montmorillonite, etc.) as well as ground synthetic minerals (such as highly dispersed silicic acid, silicates, such as alkali silicates, etc.).

### Finely Divided Solid Carrier Formulations

The compounds and compositions of the present invention may be formulated for dispersion with finely divided solid carriers such as dust, talc, chalk, diatomaceous earth, vermiculite, sand, sulfur, flours, attapulgite clay, kieselguhr, pyrophyllite, calcium phosphates, calcium and magnesium carbonates, and other solids capable of acting as carriers. A typical finely divided solid formulation useful for modifying pest population levels and/or pest behavior may contain 1 part compound or composition per 99 parts of said finely divided solid carrier. In one embodiment, these finely divided solids have an average particle size of about >50 microns. In another embodiment, the finely divided solids are granules. The term “granule,” as used herein refers to particles of a diameter of about 400-2500 microns. The granules may comprise porous or nonporous particles. Finely divided solid carriers may be either impregnated or coated with the desired compound or composition. Granules generally contain 0.05-15%, preferably 0.5-5%, of the active compound or composition. Thus, the repellent compositions of the present invention can be formulated with any of the following solid carriers such as bentonite, fullers earth, ground natural minerals (such as kaolins, quartz, attapulgite, montmorillonite, etc.), ground synthetic minerals (such as highly-dispersed silicic acid, alumina and silicates), crushed and fractionated natural rocks (such as calcite, marble, pumice, sepiolite and dolomite), synthetic granules of inorganic and organic meals, and granules of organic materials (such as sawdust, coconut shells, corn cobs, tobacco stalks, walnut or other nut shells, egg shells and other natural cast off products that may or may not be a by-product of manufacturing or harvest).

### Surface Active Agents

Formulations containing compounds and compositions of the present invention may include surface-active agents. “Surface-active agents” as referred to herein, are additives capable of lowering the surface tension of a liquid or between a liquid and a solid. Surface-active agents may include, but are not limited to emulsifying agents (such as non-ionic and/or anionic emulsifying agents, polyethylene oxide esters of fatty acids, polyethylene oxide ether of fatty alcohols, alkyl sulfates, alkyl sulfonates, aryl sulfonates, albumin hydrolyzates, alkyl arylpolyglycol ethers, magnesium stearate, sodium oleate, etc.) and/or dispersing agents (such as lignin, sulfite waste liquors, methyl cellulose, etc.)

### Thickeners

Formulations containing compounds or compositions of the present invention may contain one or more thickeners. The term “thickener”, as used herein refers to an additive that increases the viscosity of the formulation to which it is added without significantly modifying other properties of the formulation. They may also be used to impart a uniform consistency to the formulation. They are also useful for keeping components of a given formulation in suspension. Said thickeners include, but are not limited to agar, corn starch, guar gum and potato starch. Thickeners may be present at a concentration from about 0.1% to about 5% of the total composition.

### Preservatives

Formulations containing compounds or compositions of the present invention may contain one or more preservatives. The term “preservative,” as used herein refers to an additive capable of preventing decay, decomposition or spoilage in a composition. Said preservatives may be natural or synthetic; they may protect against a broad spectrum of spoilage or be targeted to one form (such as microbial, fungal or molding spoilage). Preservatives may include, but are not limited to calcium propionate, sodium nitrate, sodium nitrite, sulfur dioxide, sodium bisulfate, potassium hydrogen sulfite, disodium ethylenediaminetetraacetic acid (EDTA), formaldehyde, glutaraldehyde, ethanol, methylchloroisothiazolinone, potassium sorbate and the like. Other preservatives protect against chemical breakdown of compounds or compositions. Such preservatives include butylated hydroxyanisole (BHA) and butylated hydroxytoluene (BHT). Preservatives are typically present in formulations at a concentration from about 0.03% to about 3% by weight.

### Other Ingredients

The compounds and compositions of the invention may include “other ingredients” known to those skilled in the art and which may be added to formulations depending on the desired application. These include, but are not limited to milk, garlic, garlic powder, garlic oil, hot pepper, white pepper, oil of black pepper, piperine, chemically formulated pepper, clove, fish oil, optionally modified oil, onion, perfumes, bitrex, thiram, thymol, capsaicin, predator urines, urea, naphthalene (moth balls), pyrethrine, blood, blood meal, bone meal, sulfurous emitting items (eggs, sulfur, meats, etc), denatonium benzoate, formaldehyde, ammonia, methyl ammonium saccharide, ammonium of fatty acids, waxes, nutrients, butyl mercaptan, mineral oil, orange oil, kelp (seaweed), whole eggs, powdered eggs, putrescent eggs, egg whites, egg yolks, rotten eggs, rosemary, thyme, wintergreen, clay, 2-propenoic acid, potassium salt, 2-propeniamide, acetic acid, iron, manganese, boron, copper, cobalt, molybdenum, zinc, latex, animal glue and stickers like nufilm p and others in the series.

### Environmentally Safe Compounds

Formulations of compounds and compositions of the invention may contain environmentally safe compounds. As used herein, an “environmentally safe compound” is a compound that imposes reduced, limited, minimal and/or no harm to a given ecosystem or environment. Harmful chemicals are often used to control pests and biting insects. With increasing public awareness of the dangers posed by some chemicals to public health and to the environment, natural compounds have been increasingly explored as alternatives to synthetic and/or hazardous chemicals. To this end, the Environmental Protection Agency has taken legislative action to categorize certain natural compounds as safe, protecting the use of these environmentally safe compounds from certain government regulations. The Federal Insecticide, Fungicide and Rodenticide Act (FIFRA) outlines the exemptions as well as compounds covered by the act. In some embodiments, environmentally safe compounds include those identified as environmentally safe to use in pesticides by the Federal Insecticide, Fungicide and Rodenticide Act (FIFRA). Such compounds include, but are not limited to: (+)-butyl lactate; (+)-ethyl lactate; 1,2-propylene carbonate; 1-monolaurin; 1-monomyristin; 2-phenethyl propionate (2-phenylethyl propionate); acetyl tributyl citrate; agar; almond hulls; almond shells; alpha-cyclodextrin; aluminatesilicate; aluminum magnesium silicate; aluminum potassium sodium silicate; aluminum silicate; aluminum sodium silicate; aluminum sodium silicate (1:1:1); ammonium benzoate; ammonium stearate; amylopectin, acid-hydrolyzed, 1-octenylbutanedioate; amylopectin, hydrogen 1-octadecenylbutanedioate; animal glue; ascorbyl palmitate; attapulgite-type clay; beeswax; bentonite; bentonite, sodian; beta-cyclodextrin; bone meal; bran; bread crumbs; butyl lactate; butyl stearate; calcareous shale; calcite (Ca(Co₃)); calcium acetate; calcium acetate monohydrate; calcium benzoate; calcium carbonate; calcium citrate; calcium octanoate; calcium oxide silicate (Ca₃O(SiO₄)); calcium silicate; calcium stearate; calcium sulfate; calcium sulfate dihydrate; calcium sulfate hemihydrate; canary seed; carbon; carbon dioxide; carboxymethyl cellulose; cardboard; carnauba wax; carob gum; carrageenan; caseins; castor oil; castor oil, hydrogenated; cat food; cedar oil; cellulose; cellulose acetate; cellulose mixture (with cellulose carboxymethyl ether, sodium salt); cellulose, pulp; cellulose, regenerated; cheese; chlorophyll a; chlorophyll b; cinnamon and cinnamon oil; citric acid; citric acid, monohydrate; citronella and citronella oil; citrus meal; citrus pectin; citrus pulp; clam shells; cloves and clove oil; cocoa; cocoa shell flour; cocoa shells; cod-liver oil; coffee grounds; cookies; cork; corn cobs; corn gluten meal; corn oil; cotton; cottonseed meal; cottonseed oil; cracked wheat; decanoic acid, monoester with 1,2,3-propanetriol; dextrins; diatomaceous earth (less than 1% crystalline silica); diglyceryl monooleate; diglyceryl monostearate; dilaurin; dipalmitin; dipotassium citrate; disodium citrate; disodium sulfate decahydrate; dodecanoic acid, monoester with 1,2,3-propanetriol; dolomite; douglas fir bark; dried blood; egg shells; eggs; ethyl lactate; eugenol; feldspar; fish meal; fish oil (not conforming to 40 CFR 180.950); fuller's earth; fumaric acid; gamma-cyclodextrin; garlic and garlic oil; gelatins; gellan gum; geraniol; geranium oil; glue (as depolymerized animal collagen); glycerin; glycerol monooleate; glyceryl dicaprylate; glyceryl dimyristate; glyceryl dioleate; glyceryl distearate; glyceryl monomyristate; glyceryl monooctanoate; glyceryl monooleate; glyceryl monostearate; glyceryl stearate; granite; graphite; guar gum; gum arabic; gum tragacanth; gypsum; hematite (Fe₂O₃); humic acid; hydrogenated cottonseed oil; hydrogenated rapeseed oil; hydrogenated soybean oil; hydroxyethyl cellulose; hydroxypropyl cellulose; hydroxypropyl methyl cellulose; Iron magnesium oxide (Fe₂MgO₄); iron oxide (Fe₂O₃); iron oxide (Fe₂O₃), hydrate; iron oxide (Fe₃O₄); iron oxide (FeO); isopropyl alcohol; isopropyl myristate; kaolin; lactose; lactose monohydrate; lanolin; latex rubber; lauric acid; lauryl sulfate; lecithins; lemon grass oil; licorice extract; lime (chemical) dolomitic; limestone; linseed oil; magnesium benzoate; magnesium carbonate; magnesium oxide; magnesium oxide silicate (Mg₃O(Si₂O₅)₂), monohydrate; magnesium silicate; magnesium silicate hydrate; magnesium silicon oxide (Mg₂Si₃O₈); magnesium stearate; magnesium sulfate; magnesium sulfate heptahydrate; malic acid; malt extract; malt flavor; maltodextrin; methylcellulose; mica; mica-group minerals; milk; millet seed; mineral oil (U.S.P.); mint and mint oil; monomyristin; monopalmitin; monopotassium citrate; monosodium citrate; montmorillonite; myristic acid; nepheline syenite; nitrogen; nutria meat; nylon; octanoic acid, potassium salt; octanoic acid, sodium salt; oils, almond; oils, wheat; oleic acid; oyster shells; palm oil; palm oil, hydrogenated; palmitic acid; paper; paraffin wax; peanut butter; peanut shells; peanuts; peat moss; pectin; peppermint and peppermint oil; perlite; perlite, expanded; plaster of paris; polyethylene; polyglyceryl oleate; polyglyceryl stearate; potassium acetate; potassium aluminum silicate, anhydrous; potassium benzoate; potassium bicarbonate; potassium chloride; potassium citrate; potassium humate; potassium myristate; potassium oleate; potassium ricinoleate; potassium sorbate; potassium stearate; potassium sulfate; potassium sulfate; pumice; putrescent whole egg solids; red cabbage color (expressed from edible red cabbage heads via a pressing process using only acidified water); red cedar chips; red dog flour; rosemary and rosemary oil; rubber; sawdust; sesame (includes ground sesame plant stalks) and sesame oil; shale; silica (crystalline free); silica gel; silica gel, precipitated, crystalline-free; silica, amorphous, fumed (crystalline free); silica, amorphous, precipitated and gel; silica, hydrate; silica, vitreous; silicic acid (H₂SiO₃), magnesium salt (1:1); soap (the water soluble sodium or potassium salts of fatty acids produced by either the saponification of fats and oils, or the neutralization of fatty acid); soapbark (Quillaja saponin); soapstone; sodium acetate; sodium alginate; sodium benzoate; sodium bicarbonate; sodium carboxymethyl cellulose; sodium chloride; sodium citrate; sodium humate; sodium lauryl sulfate; sodium oleate; sodium ricinoleate; sodium stearate; sodium sulfate; sorbitol; soy protein; soya lecithins; soybean hulls; soybean meal; soybean oil; soybean, flour; stearic acid; sulfur; syrups, hydrolyzed starch, hydrogenated; tetragylceryl monooleate; thyme and thyme oil; tricalcium citrate; triethyl citrate; tripotassium citrate; tripotassium citrate monohydrate; trisodium citrate; trisodium citrate dehydrate; trisodium citrate pentahydrate; ultramarine blue; urea; vanillin; vermiculite; vinegar (maximum 8% acetic acid in solution); Vitamin C; Vitamin E; walnut flour; walnut shells; wheat; wheat flour; wheat germ oil; whey; white mineral oil (petroleum); white pepper; wintergreen oil; wollastonite (Ca(SiO₃)); wool; xanthan gum; yeast; Zeolites (excluding erionite (CAS Reg. No. 66733-21-9)); Zeolites, NaA; zinc iron oxide; zinc metal strips (consisting solely of zinc metal and impurities); zinc oxide (ZnO) and zinc stearate.

In some embodiments, compositions used in conjunction with delivery systems of the invention include compositions having at least one environmentally safe compound. Some compositions may include lemon grass oil. Some compositions may include lemon grass oil and at least one of peppermint oil, thyme oil, wintergreen oil, and vanillin. Such compositions may be prepared using a repellent concentrate. Repellent concentrates may, for example, include peppermint oil, thyme oil, wintergreen oil, vanillin, lemongrass oil, and corn oil. Such repellent concentrates may include from about 1 to about 10 weight percent of peppermint oil, from about 20 to about 30 weight percent of thyme oil, from about 10 to about 20 weight percent of wintergreen oil, from about 5 to about 15 weight percent of vanillin, from about 30 to about 40 weight percent of lemon grass oil, and from about 5 to about 15 weight percent corn oil.

Compositions having at least one environmentally safe compound that are used in conjunction with delivery systems of the invention may be packaged into any delivery unit taught herein. In some cases, such delivery units include at least one housing layer. The housing layer may be a capsule. Capsules may comprise a material capable of chemically reacting upon exposure to water. Such materials may include gelatin. In some cases, capsules may include at least one buoyancy pocket, for example, any buoyancy pocket taught herein.

### Other Aromatics

Formulations of compounds and compositions of the invention may contain other aromatic compounds or compositions. The term “aromatic” as used herein refers to a compound having a distinctive smell or aroma. Such compounds are typically volatile allowing for rapid diffusion into the surrounding air and easily sensed within the olfactory system. One such aromatic compound is cedar oil. Cedar oil may be useful in a given formulation for its ability to both repel insects as well as to kill larval mosquitoes present in a body of water. Cedar oil formulations may contain from about 0.01% to about 10%, from about 1% to about 5%, from about 2% to about 20% or from about 5% to about 50% cedar oil by weight percent.

Other aromatics that may be included in formulations of compounds and compositions of the invention include, but are not limited to camphor, pyrethrin and permethrin. Such formulations may contain from about 0.01% to about 10%, from about 1% to about 5%, from about 2% to about 20% or from about 5% to about 50% camphor, pyrethrin and/or permethrin by weight percent.

### Adjuvants

Formulations of compounds and compositions of the invention may comprise adjuvants. The term “adjuvant”, as used herein refers to any substance that improves or enhances one or more properties of another component within the formulation. Said adjuvants may include, but are not limited to buffers, acidifiers, wetting agents, spreading agents, sticking agents, adhesives, colorants, stabilizers, waterproofing agents, foam retardants and the like.

Formulations with Other Known Agents

Formulations comprising compounds and compositions of the invention may combine said compounds and compositions with other compatible active agents known in the art including pesticides, insecticides, bactericides, fungicides, acaricides, microbicides, rodenticides, nematocides, herbicides and the like. The term “bactericide” refers to substances which may destroy or blocking the growth of bacteria; “fungicide” refers to substances which may destroy or block the growth of fungi; “acaricide” refers to substances which may destroy or block the growth of members of the Arachnida subclass, Acari; “microbicide” refers to substances which may kill or block the growth of microorganisms; “rodenticide” refers to chemical substances which may be capable of destroying rodents; “nematocide” refers to chemical substances which may be capable of destroying or blocking the growth of nematodes; “herbicide” refers to chemical substances which may be capable of destroying or blocking the growth of plant life.

### Concentrations and Combinations

The compounds and compositions of the invention may be produced or formulated in various concentrations depending upon the desired application, pest, desired effect on neuronal activity and depending upon the type of surface or area that the invention will be applied to.

Typically active components within a given composition will be present in the composition in a concentration of at least about 0.0001% by weight. In another embodiment, active components may be present at a concentration from about 0.001% to about 0.01%, from about 0.001% to about 0.02%, from about 0.001% to about 0.03%, from about 0.001% to about 0.04%, from about 0.001% to about 0.05%, from about 0.001% to about 0.06%, from about 0.001% to about 0.07%, from about 0.001% to about 0.08%, from about 0.001% to about 0.09%, from about 0.001% to about 0.10%, from about 0.001% to about 0.11%, from about 0.001% to about 0.12%, from about 0.001% to about 0.13%, from about 0.001% to about 0.14%, from about 0.001% to about 0.15%, from about 0.001% to about 0.16%, from about 0.001% to about 0.17%, from about 0.001% to about 0.18%, from about 0.001% to about 0.19%, from about 0.001% to about 0.20%, from about 0.001% to about 0.21%, from about 0.001% to about 0.22%, from about 0.001% to about 0.23%, from about 0.001% to about 0.24%, from about 0.001% to about 0.25%, from about 0.001% to about 0.26%, from about 0.001% to about 0.27%, from about 0.001% to about 0.28%, from about 0.001% to about 0.29%, from about 0.001% to about 0.30%, from about 0.001% to about 0.31%, from about 0.001% to about 0.32%, from about 0.001% to about 0.33%, from about 0.001% to about 0.34%, from about 0.001% to about 0.35%, from about 0.001% to about 0.36%, from about 0.001% to about 0.37%, from about 0.001% to about 0.38%, from about 0.001% to about 0.39%, from about 0.001% to about 0.40%, from about 0.001% to about 0.41%, from about 0.001% to about 0.42%, from about 0.001% to about 0.43%, from about 0.001% to about 0.44%, from about 0.001% to about 0.45%, from about 0.001% to about 0.46%, from about 0.001% to about 0.47%, from about 0.001% to about 0.48%, from about 0.001% to about 0.49%, from about 0.001% to about 0.50%, from about 0.1% to about 1.0%, from about 0.1% to about 1.5%, from about 0.1% to about 2.0%, from about 0.1% to about 2.5%, from about 0.1% to about 3.0%, from about 0.1% to about 3.5%, from about 0.1% to about 4.0%, from about 0.1% to about 4.5%, from about 0.1% to about 5.0%, from about 0.1% to about 5.5%, from about 0.1% to about 6.0%, from about 0.1% to about 6.5%, from about 0.1% to about 7.0%, from about 0.1% to about 7.5%, from about 0.1% to about 8.0%, from about 0.1% to about 8.5%, from about 0.1% to about 9.0%, from about 0.1% to about 9.5%, from about 0.1% to about 10.0%, from about 0.1% to about 10.5%, from about 0.1% to about 11.0%, from about 0.1% to about 11.5%, from about 0.1% to about 12.0%, from about 0.1% to about 12.5%, from about 0.1% to about 13.0%, from about 0.1% to about 13.5%, from about 0.1% to about 14.0%, from about 0.1% to about 14.5%, from about 0.1% to about 15.0%, from about 0.1% to about 15.5%, from about 0.1% to about 16.0%, from about 0.1% to about 16.5%, from about 0.1% to about 17.0%, from about 0.1% to about 17.5%, from about 0.1% to about 18.0%, from about 0.1% to about 18.5%, from about 0.1% to about 19.0%, from about 0.1% to about 19.5%, from about 0.1% to about 20.0%, from about 1% to about 5%, from about 1% to about 10%, from about 1% to about 15%, from about 1% to about 20%, from about 1% to about 25%, from about 1% to about 30%, from about 1% to about 35%, from about 1% to about 40%, from about 1% to about 45%, from about 45% to about 50% (including, for example, about 45.5%, 46%, 46.5%, 47%, 47.5%, 48%, 48.5%, 49% or 49.5%,) from about 1% to about 50%, from about 1% to about 55%, from about 1% to about 60%, from about 1% to about 65%, from about 1% to about 70%, from about 1% to about 75%, from about 1% to about 80%, from about 1% to about 85%, from about 1% to about 90%, from about 1% to about 95%, from about 1% to about 100%, from about 10% to about 20%, from about 10% to about 30%, from about 10% to about 40%, from about 10% to about 50%, from about 10% to about 60%, from about 10% to about 70%, from about 10% to about 80%, from about 10% to about 90%, or from about 10% to about 100% by weight. Additionally, compounds may be combined in various embodiments such that compositions and formulations of the present invention contain 2, 3, 4, 5, 6, 7, 8, 9, 10, 11, 12, 13, 14, 15, 16, 17, 18, 19, 20 or more active compounds or compositions.

Units of measure used herein embrace standard units as well as metric units. It is to be understood that where compounds or compositions are measured, formulated or packaged in liquid form, the units may be in increments of ounces, cups, pints, quarts, gallons, barrels, or portions thereof. They may also be in metric increments of milliliters, cubic centimeters, deciliters, liters, cubic meters or portions thereof.

It is to be understood that where compounds and compositions are measured, formulated or packaged as solids, the units may have increments of ounces, pounds, tons, or portions thereof. They may also comprise increments of milligrams, grams, kilograms, metric tons or portions thereof.

Coverage, as it relates to the effective surface or area where pest population levels and/or behavior may be modified in response to application of a compound or composition of the invention, may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof.

### Application of Pest Control Compounds or Compositions

Compounds and compositions of the invention may be used to modify pest (e.g., vector pest) population levels and/or behavior in a given area. Human and non-human animal subjects may benefit from such use. As used herein, the term “subject” refers to any organism, human or non-human. Non-human animals may include, but are not limited to dogs, cats, mice, rats, rabbits, horses, cattle, sheep, goats, pigs, rodents, chickens, etc. In some embodiments, subjects may be part of a subject population that may benefit from the application of compounds and compositions of the present disclosure. Such subject populations may include human populations and/or sub populations thereof. In some cases, subject populations refer to populations of pregnant women or women who are able to become pregnant.

Coverage, as it relates to the radius of compound, combination or composition distribution by devices of the invention, may be expressed in inches, feet, square feet, yards, square yards, acres, square acres, or portions thereof. They may also be in increments of millimeters, square millimeters, centimeters, square centimeters, meters, square meters, hectares, kilometers, square kilometers or portions thereof. Conversion between the standard and metric systems is readily understood in the art and particularly by those of skill in the art. Therefore, the present invention which teaches formulations by percent and ratios of repellent or attractant compounds are not limited to any particular system of measurement. For example, while the instant examples may describe the use of a single system, the present invention is just as clear on the formulation of a quart of repellent composition as a liter of repellent composition.

Application may be indirect. For example, containers or vessels holding an amount of a compound or combination of the invention may be placed in an area to be treated with dispersion of the compound or combination being effected by forces of nature, e.g., wind, rain, current, radiant heat. Air spraying apparatuses may be employed such as those disclosed in U.S. Pat. No. 4,172,557, the contents of which are incorporated herein in entirety. Dispersion may also be effected from a container whereby dispersion is activated by movement such as a motion sensor. Aerosol dispersion is particularly amenable to automatic release via motion detection. Indirect methods also include the use of mechanical devices to effect the applications listed herein. For example, timed spreaders or broadcasters may be set up in predetermined areas in order to apply or disperse the compounds or combination of the invention to a surface, area or substrate in a temporal fashion, e.g., automated application. Triggering of timed spreaders or timed distribution may be predetermined or may occur on signal either remotely initiated or initiated as part of a timed sequence after a detection event. For example, application of the compounds or combination of the invention may occur at a time after trigger by a motion detector of the presence of a pest.

Indirect methods also include the use of devices such as those disclosed in U.S. Pat. No. 6,192,621, the contents of which are incorporated herein by reference in their entirety. In this application, the compounds or combination of the invention, alone or in combination with other agents or repellents are installed in a device capable of repelling or attracting pests to any area in which the device is placed.

Compounds and combinations formulated for timed-release, extended release and/or controlled release applications are also contemplated with or without the aid of a device. As used herein “time release” or “timed release” refers to dispersion of compounds or combinations of the invention over a period of time. The period of time may be in measured in days, weeks or months. “Extended release” refers to dispersion of compounds or combinations of the invention over an extended period of time. Extended release compositions are by definition time-release compositions. Extended release compositions are those which exert their effects over a period of time greater than one week. As used herein “controlled release” means the liberation of compounds or combinations of the invention into the intended environment in a regular manner or pattern. Controlled release formulations are often timed release formulations although the amount released in any one time across a gradient may vary.

Controlled release formulations in polymeric vehicles have been used for delivery of pesticides, insecticides, fertilizer, detergents, perfumes and in drug delivery. U.S. Pat. No. 5,017,377 to Sikinama et al. discloses a controlled release insect pest repellent used in many settings including p-menthane-3,8-diol blended with an ethylene vinyl acetate copolymer, and is herein incorporated by reference in its entirety.

Controlled release formulations of the present invention can be formulated using either non-degradable or degradable materials. In one embodiment, a polymeric capsule is formed around or incorporating the compounds and combinations to be delivered. The type of compound or combination being delivered and the environment in which the compound or combination is intended to be used determine the composition of the polymer or polymers used and the method that can be used to incorporate the compound or combination. Alternatively, the polymer can be in the form of a sheet, pellets, a film, or a shaped article.

Timed release formulations of the invention may be prepared in any of several ways. They may be prepared and coated onto, contained within or encapsulated in a physical container, granule, polymer, substrate or barrier which breaks down, corrodes or erodes to release the compounds or combinations of the invention. When formulated in this manner, the granule, substrate or barrier composition need not be homogeneous in size or content. Hence the time release can be controlled by the size or make-up of the material or materials used as a substrate.

Compounds or combinations of the invention may also be encapsulated within a coating or chemical layer which, upon contact with water, oxygen, or other environment, chemically reacts to dissolve or degrade the coating or layer thereby releasing the compound or combination.

Where encapsulation of a compound or combination is desired, such as where the compound or combination is to be used in a time release manner or where direct contact with the compound or combination is undesirable, compression within a tablet or cake or containment within a capsule may be employed.

In the tablet/cake embodiment, the tablet formulation may comprise multiple layers comprising a different concentration of formulation in each. Layers may be the same size or vary in size based on the amount of formulation to be released. For example, a binary base formulation, with no additional ingredients may be used in the outer layer or layers for an early concentrated release of repellent while a more dilute formulation having longer release characteristics may be contained deeper within the tablet for extended release effect. In this embodiment, tablets or cakes may be formed in any shape or size suitable to the application. It is well within the skill of one in the art to form tablets or cakes.

For encapsulation, any number of biodegradable polymers or substrates may be used to surround an effective amount of compounds or combinations of the invention. The compounds or combinations of the invention may be encapsulated into a matrix by the methods disclosed in U.S. Pat. No. 6,500,463, the contents of which are incorporated herein by reference in their entirety. They may also be incorporated into hydrophobic thermoplastic polymers such as those described in U.S. Pat. No. 6,852,328 to form controlled release matrices. U.S. Pat. No. 6,852,328 is herein incorporated by reference in its entirety.

The compounds or combinations of the invention may also be formulated in hydrogel microbeads each comprising a plurality of active material droplets entrained within a hydrophilic matrix that is cured chemically as disclosed in U.S. Pat. No. 6,793,937, the contents of which are incorporated herein by reference in their entirety.

The compounds or combinations of the invention may be incorporated into inorganic polymer complexes for controlled release as in U.S. Pat. No. 6,391,336; employed in granulation methods alone or as an additive as in the methods of U.S. Pat. Nos. 6,331,193 and 6,299,663; combined with insecticidal proteins such as by the methods disclosed in U.S. Pat. Nos. 6,221,649 and 6,110,463; incorporated into biodegradable plastic products made of coconut mesocarp as disclosed in U.S. Pat. No. 6,083,621; combined with microencapsulated phase change materials such as those described in U.S. Pat. No. 6,057,266 to improve time release; may be incorporated into coated granular pesticide formulations such as those disclosed in U.S. Pat. No. 6,036,971; incorporated into the time release systems described in U.S. Pat. No. 6,004,572; encapsulated in thermoplastic resins such as those described in U.S. Pat. No. 5,679,129; layered into slow release granules such as those in U.S. Pat. No. 4,971,796; or adsorbed in organoclay controlled release formulations such as those disclosed in U.S. Pat. No. 4,849,006, the contents of each patent of which is incorporated herein by reference in its entirety.

The compounds or combinations of the invention may be applied or delivered using osmotic devices such as those described in U.S. Pat. No. 6,491,949, the contents of which are incorporated herein by reference in their entirety.

Controlled delivery of compounds or combinations of the invention may be to a body of water such as is disclosed in U.S. Pat. Nos. 5,902,596, 5,885,605 and 5,858,384, the contents of each which are incorporated by reference in their entirety. They may also be formulated for controlled release on land by incorporation into superabsorbent polymers such as those described in U.S. Pat. No. 4,983,390, the contents of which are herein incorporated by reference in their entirety. Time release may be effected via wicking of the compounds or combinations of the invention into the atmosphere. As used herein “wicking” is the process by which a liquid is moved via capillary action up a tube or along a material. In the present invention, the compounds or combinations may be placed in a container with one or more materials used to “wick” the compounds or combinations out of the container into the atmosphere. Wicking can be facilitated or non-facilitated. Facilitated wicking occurs via the use of one or more external energy sources such as via the application of heat or use of a fan or both. Non-facilitated wicking occurs naturally in the absence of any applied external energy source, e.g., evaporation.

Time release may be effected by the direct application of heat to either the compounds or combinations alone or to the container in which the compounds or combinations are placed.

Time released formulations may be placed around buildings, garden areas, vineyards, turf areas, sports fields, parks, campsites, barns, farms, greenhouses, and the like. These may also be placed along side roads or other throughways such and walkways and entrances to limit pest entry.

In one embodiment time release devices include porous bodies or other bodies that can contain a compound or combination and release the compound or combination over time. An exemplary container includes a formulation that comprises a compound or combination of the present invention wherein the container allows for time release of the compound or combination over a period of one month or more.

Various types of solid materials may be protected by the disclosed compounds or combinations. Plant material, including woody plants may be protected from pests. Plant material, including grasses, may be treated to prevent pests from alighting on the plant.

Exterior surfaces of buildings, walls, concrete and asphalt and other solid non-living surfaces may be treated to prevent pests from alighting on, approaching or otherwise contacting such surfaces.

### III. Methods and Systems of Delivery

In some embodiments, the present invention provides a method for aerial delivery of one or more delivery units to a target area. In one embodiment, the method comprises delivering the one or more delivery units to the target area using an aerial delivery vehicle fitted with a delivery structure as defined herein. In a further embodiment, the target area is remote. By remote is meant that the target area is not easily accessible e.g. due to the condition or lack of roads, trails, tracks or paths thereto. A target area may also be deemed remote due to the distance thereof from a habited region.

In some embodiments, the target area is any non-enclosed area for which delivery of one or more delivery units is desired. In one embodiment, the target area is on land. In another embodiment, the target area is a body of water (e.g., pond, lake, bog, swamp, estuary, river, stream, brook, marsh, delta, bay, cove, etc.).

In some embodiments, the present invention provides a method for aerial delivery of a payload to two or more target areas without having to land the aerial delivery vehicle. In one embodiment this is achieved by flying the aerial delivery vehicle to a first target area, independently actuating release of one or more of the delivery units, and flying the aerial delivery vehicle to one or more additional target areas where release of the one or more delivery units is independently actuated.

In a particular embodiment, the present invention provides a method for aerial delivery of a biocide to two or more bodies of water using an aerial delivery vehicle fitted with a delivery structure as defined herein. In one embodiment the biocide is larvicide.

The present invention also provides a method for controlling the pest population at one or more target locations, the method comprising delivering a pest control compound or composition as defined herein to the target location using an aerial vehicle fitted with a delivery structure as defined herein. In one embodiment, the one or more target locations are remote, in a further embodiment the one or more target locations are remote bodies of water, and in a still further embodiment the pest control compound or composition is a biocide (e.g. a larvicide).

In some embodiments of the present invention, there are also provided systems for carrying out the methods described herein. In one embodiment, the system comprises an aerial vehicle fitted with a delivery structure as defined herein, a pest control compound or composition payload contained within delivery units, and a remote transmitting station for wirelessly providing instructions to the aerial delivery vehicle and/or delivery structure. The remote transmitting station may comprise, e.g., a radio control transmitter for operation by a pilot or by an autonomous system. The radio control transmitter may be integrated with, or operatively connected to, a computer, e.g. a portable computer. Suitable radio control transmitters for operating an aerial delivery vehicle and/or a delivery structure as described herein will be known to the person of skill in the art.

In some embodiments, aerial delivery vehicles of the invention may be used to interrogate target areas (e.g., unknown environments, remote location or harsh environments). In some cases, such aerial delivery vehicles may delivery one or more sensors, cameras, or other equipment that may be used to retrieve information about the target area.

Delivery units may be dropped by aerial delivery vehicles from any altitudes. Aerial delivery vehicle altitude may be measured using any unit of distance from a base level. Units of distance may include, but are not limited to meters, kilometers, inches, feet, yards, miles, etc. Base levels may include, but are not limited to water level, ground level, platform level, etc. In some embodiments, delivery units dropped by aerial delivery vehicles of the invention are dropped from altitudes that may include, but are not limited to at least 1 ft, at least 50 ft, at least 100 ft, at least 1,000 ft, at least 5,000 ft, at least 10,000 ft, or at least 30,000 ft above sea level. When dropped by aerial delivery vehicles being operated remotely, delivery units may be dropped at short or large distance from a remote pilot. Such distances may include, but are not limited to from about 0.01 miles to about 0.1 miles, from about 0.05 miles to about 0.5 miles, from about 0.1 miles to about 0.6 miles, from about 0.2 miles to about 1.0 miles, from about 0.7 miles to about 5.0 miles, from about 2 miles to about 20 miles, from about 5 to about 100 miles, from about 10 to about 200 miles, from about 150 miles to about 500 miles, from about 300 miles to about 1,000 miles, from about 600 miles to about 2,000 miles, from about 750 miles to about 3,000 miles, or at least 3,000 miles.

In some embodiments, methods of the invention include methods of reducing the level of vector-borne illness in a subject population. Such methods may include the use of delivery systems disclosed herein. According to such methods, delivery systems may be used to deliver at least one pest control compound or composition to a target area. The target area may contain, be adjacent to, or be utilized by a subject population. In some cases, such methods are intended to benefit the subject population. In some cases, the vector-borne illness may be a mosquito-borne illness. Such mosquito-borne illnesses may include any of those taught herein including, but not limited to, malaria, Dengue fever, yellow fever, sleeping sickness, West Nile virus infection, Eastern equine encephalitis, river blindness, lymphatic filariasis, leishmaniasis, epidemic polyarthritis, Australian encephalitis, and Zika virus infection. In some cases, the target area is a body of water.

In some embodiments, the present disclosure provides methods of preventing or reducing vector-associated birth defects in a subject population. Such methods may include obtaining a delivery system disclosed herein. According to such methods, delivery systems may be used to deliver at least one pest control compound or composition to a target area. The target area may contain, be adjacent to, or be utilized by a subject population that the method is intended to benefit. In some cases, the vector-associated birth defects are caused by a vector-borne illness, such as Zika virus infection. The vector-associated birth defects may include neurological defects, such as microcephaly. In some cases, the target area is a body of water.

### IV. Kits and Retail Products

The devices of the present invention may be prepared as components of kits or other retail products for commercial sale or distribution. These kits may be sold to retailers for the purpose of selling these retail products for public use according to the methods disclosed herein. As such the present invention embraces methods of manufacturing or production of kits and or products to be provided to an end-user. Kits may contain packaging; containers comprising compounds, compositions or combinations for pest control; and optionally instructions for use.

Devices of the present invention may be sold in modular form for assembly or reconstruction by a subsequent individual or end user as a kit. Said kits may be provided complete with all necessary components to assemble the devices. In another embodiment, said kits provide a partial number of components necessary and require that the subsequent user or end user provide one or more components separately (such as screws, bolts, liquid, etc.).

In one embodiment, a kit of the present invention may comprise parts of a delivery structure, including an attachment section and one or more delivery units as defined herein. The kit may further comprise spacer elements and/or a holding rack as defined herein. In some embodiments the kit may comprise instructions for assembling the attachment section, one or more delivery units, spacer elements, releasing units, cargo holders and/or holding rack, for attaching the delivery structure to an aerial delivery vehicle, for loading a payload within the delivery units, and/or for actuating delivery of delivery units.

In another embodiment, the kit of the present invention may comprise parts of a delivery structure, including an attachment section and a holding rack as defined herein. The kit may further comprise spacer elements as defined herein. In some embodiments, the kit may comprise instructions for assembling the attachment section, spacer elements, releasing units, cargo holders and/or holding rack, for attaching the delivery structure to an aerial delivery vehicle, for attaching a delivery unit to the holding rack, for actuating release of delivery units, and/or for actuating release of the attached delivery unit from releasing units attached to the holding rack.

In another embodiment, the kit of the present invention may comprise a delivery unit as described herein, together with instructions for the attachment thereof to a releasing unit of a holding rack as defined herein and/or for the loading of a payload into a delivery unit.

In another embodiment, the kit of the present invention may comprise a delivery unit and a pest control compound or composition, each as described herein, the pest control compound or composition being within or separate from the delivery unit. The kit may further comprise instructions for attachment of the delivery unit to a holding rack as defined herein, and/or the loading of the pest control compound or composition within the delivery unit.

### V. Equivalents and Scope

Those skilled in the art will recognize, or be able to ascertain using no more than routine experimentation, many equivalents to the specific embodiments in accordance with the invention described herein. The scope of the present invention is not intended to be limited to the above Description, but rather is as set forth in the appended claims.

In the claims, articles such as “a,” “an,” and “the” may mean one or more than one unless indicated to the contrary or otherwise evident from the context. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention includes embodiments in which more than one, or all of the group members are present in, employed in, or otherwise relevant to a given product or process.

It is also noted that the term “comprising” is intended to be open and permits but does not require the inclusion of additional elements or steps. When the term “comprising” is used herein, the term “consisting of” is thus also encompassed and disclosed.

Where ranges are given, endpoints are included. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise.

Where the term “about” is used, it is understood to reflect +/−10% of the recited value. In addition, it is to be understood that any particular embodiment of the present invention that falls within the prior art may be explicitly excluded from any one or more of the claims. Since such embodiments are deemed to be known to one of ordinary skill in the art, they may be excluded even if the exclusion is not set forth explicitly herein. Any particular embodiment of the compositions of the invention (e.g., any method of production; any method of use; etc.) can be excluded from any one or more claims, for any reason, whether or not related to the existence of prior art.

All cited sources, for example, references, publications, databases, database entries, and art cited herein, are incorporated into this application by reference, even if not expressly stated in the citation. In case of conflicting statements of a cited source and the instant application, the statement in the instant application shall control.

Section and table headings are not intended to be limiting.

### EXAMPLES

### Example 1. Delivery Structure

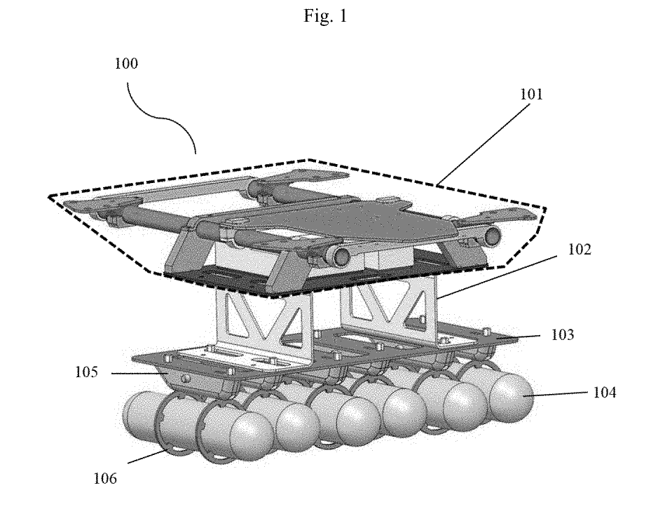

One embodiment of a delivery structure 100 according to the present invention is shown in FIG. 1. The attachment section 101, as indicated by a dotted line outline, is designed for attachment to a DJI 5900 hexacopter, is fixed to the delivery units by way of spacer elements 102. The spacer elements are fixed to a holding rack 103 which itself holds six delivery units 104. The delivery units are attached to the holding rack by releasing units 105, each releasing unit holding two cargo holders 106 that may be released to drop the delivery units.

### Example 2. Delivery Structure on DJI 5900 Hexacopter

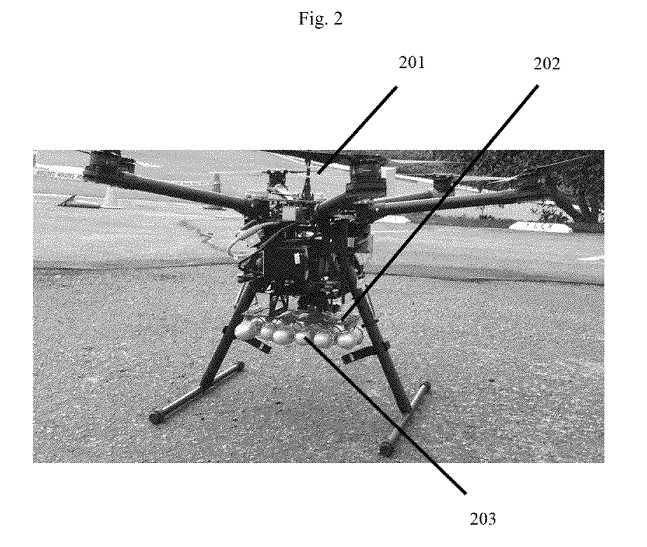

In FIG. 2, an embodiment of a system for aerial delivery of delivery units is shown. The delivery system comprises a delivery structure attached to an aerial delivery vehicle. The aerial delivery vehicle 201 is a DJI S900 hexacopter, to which is attached the delivery structure depicted in FIG. 1. The holding rack 202 is attached to the aerial delivery vehicle by way of spacer elements that connect to the attachment section, and the holding rack holds six delivery units 203.

### Example 3. Delivery Units

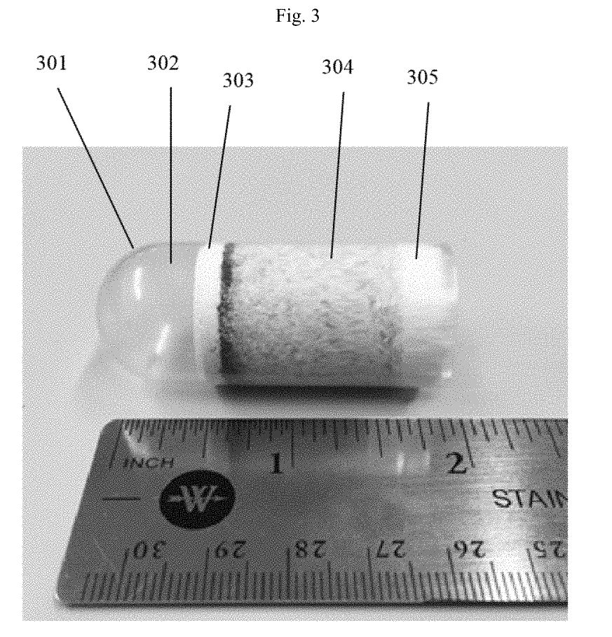

In FIG. 3, an embodiment of a capsule 301 is shown. Such payload capsules may be delivery units themselves or may be placed into an outer housing as part of a complete delivery unit. In FIG. 3, the capsule has a buoyancy pocket 302 and a payload layer 304 comprising a powdered or pelleted payload. In this case, the payload layer comprises a thin layer of fluorescein dye and thick layer of sand. The payload is capped on either end by an inner cap layer 303 and an outer cap layer 305. In this embodiment, inner and outer cap layers comprise ALKA-SELTZER® (Bayer Healthcare, LLC, Whippany, N.J.). The ALKA-SELTZER® dissolves when contacting water and produces gas. Gas production from the inner cap layer 303 helps to increase buoyancy in the buoyancy pocket 302. Dissolution of the outer cap layer 305 leads to release of the payload 304. The capsule weighs about 30 g. In some cases, both ends of such capsules may be rounded (e.g., with a rounded gelatin endcap. This capsule may be loaded into an outer housing (with a final weight of about 100 g) before attachment to a holding rack.

### Example 4. Biocide Delivery

In one embodiment, the delivery vehicle depicted in FIG. 2 can be used to deliver a biocide, e.g. larvicide, compound or composition to two or more remote bodies of water without having to land the vehicle. The delivery units are filled with biocide that is encapsulated in a water dissolvable housing (e.g. gelatin), and the delivery vehicle is remotely controlled by a human operator and brought to a first location where one or more delivery units are independently released from releasing units when actuated by a radio signal to deliver the biocide compound or composition to a first body of water. The device is then directed to a second target area at the same or at a different body of water, where one or more additional delivery units are independently released from releasing units when actuated to deliver further biocide. This can be repeated, without landing of the device, until the desired number of target areas have been exposed to the biocide. The delivery structure may be reloaded with additional delivery units or modified in the field for additional purposes.

### Example 5. System Testing

A “dummy” delivery unit is prepared for delivery to a target location. An unmanned remote operated aerial delivery vehicle, the DJI Spreading Winds 5900 hexacopter, is fitted with a delivery structure, as pictured in FIG. 2. The delivery structure is fitted with up to 6 delivery units (about 100 g each). The delivery units are prepared for individual release from the delivery structure. Delivery units are prepared as gelatin capsules filled with sand with the loaded delivery units having an approximate weight of 100 g. Once dropped into water, the gelatin capsules resolve and the sand is released. Delivery units are dropped through actuation of releasing units controlled by an RC transmitter used for piloting the aerial delivery vehicle. The aerial delivery vehicle is piloted, optionally in the line of site of the pilot, at a distance of about 100 to 1000 m. The flight time is about 5 to 30 minutes (e.g., 15 minutes).

### Example 6. Delivery to Land

Aerial delivery vehicles of the invention are used to deliver one or more payload to land-based targets. Payloads are selected from equipment, supplies, remotely controlled vehicles, and sensors.

1. A delivery structure for aerial delivery of a pest control compound or composition to a target area, the device comprising:
a. an attachment section for attaching the delivery structure to an aerial delivery vehicle; and
b. one or more delivery units adapted for containing the pest control compound or composition and adapted for releasing the pest control compound or composition to the target area.

2. The delivery structure according to claim 1, wherein the attachment section is adapted to be attached to different aerial delivery vehicles.

3. The delivery structure according to claim 1, wherein the attachment section comprises one or more spacer elements that connect to a holding rack, said holding rack comprising the delivery units.

4. (canceled)

5. The delivery structure according to claim 1, wherein the one or more delivery units are attached to said holding rack by one or more releasing units, wherein said one or more releasing units are configured for independent actuation to release one or more delivery units to the target area.

6. The delivery structure according to claim 5, wherein the one or more delivery units are attached to said one or more releasing units by one or more cargo holders and wherein actuation of the one or more releasing units causes one or more cargo holders to be released.

7. The delivery structure of claim 6, wherein each delivery unit is attached to one releasing unit by two or more cargo holders.

8. The delivery structure according to claim 1, wherein the one or more delivery units are constructed of environmentally safe and/or biodegradable material.

9. The delivery structure according to claim 7, wherein the one or more delivery units comprise at least one housing layer configured to break open upon physical contact resulting from delivery.

10. The delivery structure according to claim 7, wherein the one or more delivery units comprise at least one housing layer that has one or more openings through which the pest control compound or composition can escape into the target location.

11. The delivery structure according to claim 10, wherein the one or more openings are sufficiently small to retain the pest control compound or composition during flight, but sufficiently large to allow entry of water into the housing.

12. The delivery structure according to claim 7, wherein the one or more delivery units comprise at least one housing layer that is partially or completely constructed of a material that chemically reacts upon exposure to the environment at the target area, to dissolve or degrade and provide exposure of the pest control compound or composition to the target area.

13. The delivery structure according to claim 12, wherein the at least one housing layer dissolves or degrades upon exposure to water.

14. The delivery structure according to claim 1, comprising at least 6 delivery units, wherein the delivery units are released in the order of outermost delivery units to innermost delivery units.

15. The delivery structure according to claim 14, wherein the delivery units comprise at least one buoyancy pocket.

16-37. (canceled)

38. The delivery structure according to claim 1, wherein the pest control compound or composition comprises one or more compounds selected from the group consisting of X0001-X0190 and further comprising a commercial repellent.

39. The delivery structure according to claim 38, wherein the commercial repellent is selected from the group consisting of IR3535, lemon eucalyptus and picardin.

40. The delivery structure according to claim 1, wherein the pest control compound or composition comprises a synergistic combination of a first combination selected from the group consisting of Z0035, Z0047 and Z0078 and a commercial repellent selected from the group consisting of IR3535, lemon eucalyptus and picardin.

41-181. (canceled)
